(19) United States
(12) Patent Application Publication
(10) Pub. No.: US 2026/0112201 A1
(43) Pub. Date: Apr. 23, 2026

(54) METHOD AND SYSTEM FOR REAL-TIME BEHAVIOURAL ANALYSIS OF RODENTS

(71) Applicants: Shuhan He, Skokie, IL (US); Boyu Peng, Skokie, IL (US)

(72) Inventors: Shuhan He, Skokie, IL (US); Boyu Peng, Skokie, IL (US)

(73) Assignee: Shuhan He, Skokie, IL (US)

(21) Appl. No.: 19/360,094

(22) Filed: Oct. 16, 2025

Related U.S. Application Data
(60) Provisional application No. 63/708,558, filed on Oct. 17, 2024.

(51) Int. Cl. G06V 40/20; G06Q 30/018; G06T 7/73; G06V 10/764; G06V 10/82; H04N 23/20; H04N 23/45; H04N 23/56; H04N 23/90

(52) U.S. Cl. CPC G06V 40/20; G06T 7/73; G06V 10/764; G06V 10/82; H04N 23/20; H04N 23/45; H04N 23/56; H04N 23/90; G06Q 30/018; G06T 2207/10016; G06T 2207/10048; G06T 2207/20084

(57) ABSTRACT

The present invention relates to a system and method for real-time behavioural analysis of rodents, particularly in the context of neurological research. The system employs continuous video tracking to monitor key anatomical points, including the head, body, tail, front paws, and back paws. It integrates real-time data processing and sophisticated visualization techniques, such as heatmaps and trajectory lines, to provide detailed analysis of rodent movements. The system is scalable and automated, supporting large-scale studies and operating under naturalistic conditions, including varying light cycles. Additionally, the system features integration with MRI imaging, enabling the correlation of behavioural data with neurological assessments. This innovation offers a comprehensive solution for studying motor function and other behaviours in rodent models, significantly improving the accuracy and efficiency of preclinical research in neurological conditions.

### TECHNICAL FIELD

The disclosure generally relates to a system and method for continuous behavioural monitoring and analysis in rodents, particularly for tracking and evaluating motor functions and other behavioural parameters post-stroke or under other neurological conditions.

### BACKGROUND

Behavioural phenotyping in preclinical research, particularly involving rodent models, is crucial for understanding neurological conditions, such as those resulting from stroke. Accurately tracking and analysing rodent behaviour can provide valuable insights into motor function impairments, recovery trajectories, and the effectiveness of therapeutic interventions. Traditional methods of behavioural analysis have relied on manual observation and basic tracking technologies, which are often time-consuming, prone to human error, and limited in their ability to capture the full spectrum of rodent behaviour.

Despite advancements in video tracking and data analysis, current systems for monitoring rodent behaviour face significant limitations in terms of continuous, real-time tracking of anatomical points and the integration of this data with neurological assessments. Existing systems typically struggle with accurately capturing and analysing complex movements, particularly in scenarios where detailed tracking of specific anatomical points, such as the head, body, tail, and paws, is required. Moreover, these systems often fail to provide comprehensive visualizations and predictive analytics that are critical for understanding the nuanced effects of neurological conditions like stroke.

Several systems have been developed to track and analyse rodent behaviour, ranging from basic video recording setups to more advanced motion tracking systems. These solutions generally offer some level of automated tracking, allowing researchers to monitor rodent movement over extended periods. Additionally, some systems provide basic visualization tools to represent movement patterns and behavioural metrics. However, these existing solutions have significant shortcomings. They often lack the precision required for detailed anatomical tracking, particularly when it comes to differentiating between subtle movements of various body parts. Furthermore, while some systems offer integration with external data sources, such as MRI imaging, they do not provide seamless, real-time data synchronization, which is essential for correlating behavioural data with neurological assessments. Current solutions fall short in several critical areas.

First, they do not offer comprehensive tracking of specific anatomical points in real time, which is necessary for detailed behavioural analysis, especially in post-stroke studies. Second, the visualization tools available in existing systems are often rudimentary and fail to effectively represent the complexity of the data being collected. For example, existing systems may not provide dynamic visualizations that can illustrate the temporal and spatial relationships between different body parts. Moreover, existing systems generally do not incorporate advanced analytical tools, such as machine learning models, to predict recovery trajectories or assess the effectiveness of interventions based on early behavioural data. The lack of scalability and automation in these systems further limits their utility in large-scale research studies, where continuous, unattended monitoring is essential.

Therefore, there is a need for a method and system for real-time behavioural analysis of rodents.

### SUMMARY OF THE INVENTION

The present invention provides a system and method for real-time behavioural analysis of rodents, specifically designed to continuously track and analyse the movements of specific anatomical points such as the head, body, tail, front paws, and back paws. The system utilizes a combination of high-resolution video tracking and real-time data processing to monitor rodent behaviour continuously, providing precise and detailed insights into motor function, particularly in the context of neurological conditions such as stroke. Additionally, alternative embodiments may extend the applicability of the system to monitor rodents in models of other neurological conditions, including epilepsy or Parkinson's disease, by identifying distinct movement signatures associated with these disorders.

This method and system address the shortcomings of existing solutions by capturing and analysing the spatial and temporal relationships between various anatomical points with high accuracy. The system features an architecture that includes a server for real-time tracking of key anatomical points, with data transmission to a client responsible for real-time calculations and user interface displays. The invention supports continuous video tracking within a naturalistic environment, including varying light conditions to simulate natural day/night cycles, crucial for studying circadian rhythms and other behavioural patterns.

A key innovation of the system is its ability to provide comprehensive and interactive visualizations, such as heatmaps, trajectory lines, and synchronized video frames, which allow researchers to observe and analyse complex behaviours in detail. Additionally, the system is designed to be scalable and automated, capable of handling multiple cages and rodents simultaneously, thus supporting large-scale studies without the need for constant human oversight.

Moreover, the invention integrates with other data sources, such as MRI imaging, enabling the correlation of behavioural data with neurological assessments. This integration allows for enhanced predictive analytics, where machine learning models can forecast recovery trajectories based on early behavioural data and MRI findings.

According to a first aspect of the invention, a behavioral analysis system is provided. The system comprising: a housing configured to be positioned adjacent to an experimental enclosure; a plurality of imaging devices mounted within the housing and oriented toward a behavioral region of a subject; an illumination assembly comprising at least one infrared light source configured to provide uniform lighting within the behavioral region; a processing unit communicatively coupled to the imaging devices; and a memory storing instructions executable by the processing unit to generate synchronized multi-view video data representing movement of the subject within the behavioral region; wherein the system is configured to capture and store high-fidelity spatiotemporal movement data of the subject for subsequent behavioral analysis.

In one embodiment of the invention, the plurality of imaging devices comprises at least one wide-angle camera and one depth-sensing camera configured to generate three-dimensional representations of the subject.

In one embodiment of the invention, the illumination assembly further comprises a variable intensity controller configured to adjust infrared power based on ambient light conditions.

In one embodiment of the invention, the housing further comprises vibration isolation mounts and heat dissipation vents to maintain consistent sensor calibration and minimize motion artifacts.

In one embodiment of the invention, the system further comprising: a temperature and acoustic sensor configured to record environmental parameters corresponding to each behavioral session.

In one embodiment of the invention, the processing unit further comprises an embedded graphics processing module configured to perform frame synchronization and video compression in real time.

In one embodiment of the invention, the behavioral region is enclosed by transparent panels having anti-reflective coatings to enhance optical clarity.

In one embodiment of the invention, the imaging devices are mounted at predefined angular orientations forming a calibrated multi-view array to enable three-dimensional reconstruction of subject posture.

In one embodiment of the invention, the memory further stores calibration matrices corresponding to intrinsic and extrinsic camera parameters for stereoscopic depth computation.

According to a second aspect of the invention, a behavioral analysis system is provided. The system comprising: at least one camera configured to capture video footage of a rodent within an enclosure; a processing unit configured to receive and process tracking data from the camera; a graphical user interface (GUI) configured to display real-time tracking metrics; a behavioral recognition module implemented in software and executed by the processing unit, the module comprising: a motion detection unit configured to extract temporal features from the synchronized video data; a pose estimation unit configured to determine anatomical keypoints of the subject using a convolutional neural network; and a behavioral classification unit configured to categorize behavioral states based on extracted kinematic features; a data correlation module configured to associate the classified behaviors with physiological or pharmacological input data; and a translational analysis framework configured to project the behavioral features onto standardized human motor axes for cross-species comparison.

In one embodiment of the invention, the behavioral recognition module utilizes a deep neural network trained on multi-angle video data annotated with locomotor, grooming, and rearing behaviors.

In one embodiment of the invention, the translational analysis framework computes a concordance index representing the similarity between animal and human motor feature distributions.

In one embodiment of the invention, the system further comprising: a data export module configured to format behavioral outputs according to FAIR data standards and transmit said data to an external server.

In one embodiment of the invention, the behavioral recognition module further includes a reinforcement learning subroutine configured to adapt classification thresholds based on new experimental data.

In one embodiment of the invention, the data correlation module integrates biological readouts selected from electrophysiological, neurochemical, or imaging data streams.

In one embodiment of the invention, the translational analysis framework employs a transformation matrix trained using canonical correlation analysis to align rodent motor feature vectors with human motor domains comprising symmetry, stability, speed, smoothness, and coordination.

According to a third aspect of the invention, a method of performing automated behavioral and translational analysis is provided. The method comprising: capturing multi-view image data of a subject within an experimental region using a plurality of imaging devices; preprocessing the image data to synchronize frames and normalize illumination; extracting anatomical keypoints of the subject by applying a machine-learning model to the image data; computing behavioral features including stride length, angular displacement, and inter-limb coordination; classifying the subject's behavior based on said features using a behavioral classification algorithm; correlating the classified behavior with one or more physiological or pharmacological datasets; and projecting the correlated data into a standardized motor axis framework to generate a translational mapping between animal and human behavioral metrics.

In one embodiment of the invention, the method further comprising: performing postural reconstruction of the subject by triangulating two-dimensional keypoints from multiple synchronized camera views.

In one embodiment of the invention, the behavioral classification algorithm comprises a convolutional neural network trained on labeled behavioral video datasets.

In one embodiment of the invention, the method further comprising: exporting all derived behavioral and translational data in a standardized FAIR-compliant format for regulatory submission or external data sharing.

It is to be understood that both the foregoing general description and the following detailed description are exemplary and explanatory only and are not restrictive of the invention.

### BRIEF DESCRIPTION OF THE DRAWING

The accompanying drawings, which are incorporated in and constitute a part of this disclosure, illustrate exemplary embodiments and, together with the description, serve to explain the disclosed principles.

FIG. 1 illustrates an environment diagram where a system for real-time behavioural analysis of rodents is implemented, in accordance with an embodiment of the present disclosure.

FIG. 2 illustrates a block diagram of a real-time data processing system for real-time behavioural analysis of rodents, in accordance with an embodiment of the present disclosure.

FIG. 3 illustrates a flow diagram of a method for real-time behavioural analysis of rodents, in accordance with an embodiment of the present disclosure.

FIG. 4 illustrates an exemplary embodiment of a data standardization and export pipeline incorporated within the behavioral analysis system, in accordance with an exemplary embodiment of the present invention.

FIG. 5 illustrates a multi-camera 3D reconstruction system that forms a part of the overall behavioral analysis apparatus, in accordance with an exemplary embodiment of the present invention.

FIG. 6 illustrates an advanced machine learning and behavior discovery system configured to automatically classify, discover, and quantify behavioral motifs of the subject animal using both supervised and unsupervised computational pipelines, in accordance with an exemplary embodiment of the present invention.

FIG. 7 illustrates a physiological and biomarker sensing module integrated within the behavioral analysis system, in accordance with an exemplary embodiment of the present invention.

FIG. 8 illustrates a home-cage behavioral monitoring and circadian tracking system configured for continuous, non-intrusive observation of one or more rodents over extended durations, in accordance with an exemplary embodiment of the present invention.

FIG. 9 illustrates a multi-animal behavioral tracking and social interaction analysis system, which forms an integral extension of the behavioral monitoring platform described in FIGS. 4 to 8, in accordance with an embodiment of the present invention.

FIG. 10 illustrates a scalable, real-time data processing and cloud-based analytics architecture, configured to support high-throughput behavioral experiments across multiple cages, experimental conditions, and laboratories, in accordance with an embodiment of the present invention.

FIG. 11 illustrates a translational alignment framework designed to map rodent behavioral and kinematic parameters into standardized Neurobehavioral Assessment Matrix (NAM) or Standardized Translational-Motor Axis (ST-MAX) representations, in accordance with an embodiment of the present invention.

FIG. 12 illustrates an integrated anatomical skeleton mapping system that enables fine-grained motion reconstruction and pose analysis of small laboratory animals such as rodents, in accordance with an embodiment of the present invention.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered exemplary only. Additional illustrative embodiments are listed.

Further, the phrases “in some embodiments”, “in accordance with some embodiments”, “in the embodiments shown”, “in other embodiments”, and the like mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only.

In an embodiment, the invention comprises a system for automated behavioral monitoring of one or more rodents within an experimental or home/cage environment. The system includes a hardware module having a multi-camera imaging assembly, a lighting control module, environmental sensors, and a computing unit configured for real-time data acquisition, synchronization, and processing. The software layer is operatively coupled to the hardware components and includes machine learning-based behavioral analytics, three-dimensional pose reconstruction, data standardization, and translational mapping algorithms.

The imaging module may comprise a plurality of cameras strategically positioned around the observation arena to capture images and videos of the rodents from multiple angles. In some embodiments, the cameras are synchronized through a master clock signal to ensure frame-level temporal alignment. Each camera may include infrared and visible spectrum sensors, allowing the system to operate under various lighting conditions, including complete darkness. The data from each camera is transmitted to a local computing module through wired or wireless communication channels for processing.

In an embodiment, the computing module includes a graphics processing unit (GPU) or dedicated AI accelerator configured to perform real-time image segmentation and pose estimation. The video frames captured by the camera array are subjected to pre-processing operations such as background subtraction, noise reduction, and normalization. The processed frames are then passed to a pose-estimation module that determines body keypoints, skeletal posture, and kinematic trajectories of the animals. The pose estimation may be implemented using convolutional neural networks (CNNs), transformer-based models, or other deep learning architectures trained on labeled behavioral datasets.

The system is further configured to handle multiple animals simultaneously. In one embodiment, a tracking module assigns unique identities to each animal and maintains identity consistency across frames, even in cases of occlusion or interaction. This may be achieved using data association algorithms such as Kalman filtering, appearance embedding, or re-identification networks. The identity-tracking feature enables accurate analysis of social behaviors, aggression, mating, and dominance patterns within group-housed settings.

Another embodiment of the invention includes a three-dimensional reconstruction module that combines image data from multiple cameras to generate a volumetric or skeletal 3D representation of the animal. The module applies stereo triangulation, depth inference, and probabilistic model fusion to reconstruct fine-grained postural movements. This enables the system to quantify complex behaviors such as grooming, rearing, and object exploration with high spatial accuracy. The reconstructed 3D skeleton may also be used to derive kinematic parameters such as joint angles, stride length, or motion energy.

The analytical pipeline of the system includes an unsupervised behavioral classification module that uses pose dynamics and movement trajectories to identify distinct behavioral motifs. The classification process may employ clustering algorithms such as Hidden Markov Models (HMMs), Hierarchical Dirichlet Processes (HDP-HMM), or graph-based embedding methods to detect recurrent behavioral patterns without explicit supervision. Additionally, supervised classifiers may be trained for specific tasks such as anxiety testing, locomotion scoring, or sleep detection. The integration of both supervised and unsupervised methods allows the system to adapt to a wide variety of behavioral paradigms.

In another embodiment, the system includes a translational mapping module that correlates rodent behavioral features with human clinical metrics. This is achieved by projecting the extracted behavioral features onto standardized behavioral axes that are interpretable across species. For example, features such as exploration tendency, social interaction frequency, or motor asymmetry may be mapped onto clinically relevant scales such as anxiety, sociability, or motor impairment. The module employs regression models or neural embedding trained on cross-species datasets to generate translational scores. These scores may be used for preclinical drug efficacy testing or neurobehavioral phenotyping.

The system further integrates with multimodal biological data sources such as electrophysiology, imaging, or biochemical biomarkers. A data synchronization layer ensures temporal alignment between behavioral events and physiological signals. This multi-domain integration enables researchers to correlate behavioral outcomes with underlying neural or metabolic activity, thereby enhancing the interpretability of experimental results.

To ensure reproducibility and regulatory compliance, the data management layer of the system implements FAIR (Findable, Accessible, Interoperable, Reusable) and DMS (Data Management and Sharing) standards. Behavioral data, including video files, metadata, and extracted features, are stored in a structured format using standard ontologies and schemas. The system supports automated metadata tagging, secure cloud synchronization, and API-based interoperability with external bioinformatics platforms. This architecture enables consistent data sharing across research facilities and ensures compliance with institutional and funding agency data management requirements.

In some embodiments, the system includes a real-time feedback control mechanism configured to trigger external stimuli or devices based on detected behavioral states. For example, upon detecting a specific behavior such as freezing, the controller may activate an auditory cue, lighting change, or drug delivery system. The feedback mechanism operates through a low-latency communication channel between the AI module and peripheral hardware interfaces, enabling closed-loop experimental designs.

The invention may further include a scalable architecture that supports distributed deployment across multiple cages or experimental setups. Edge computing modules can perform on-site video processing, while aggregated data streams are transmitted to a central analysis server for high-level analytics and visualization. The modular nature of the system allows for expansion to new sensor types or behavioral paradigms without major hardware modifications.

In one example embodiment, the system is deployed in a home-cage setup to continuously monitor circadian activity, feeding patterns, and social interactions over extended durations. The low-power infrared illumination and adaptive exposure control ensure continuous operation without disturbing the animals. The system may also integrate environmental sensors for temperature, humidity, and light intensity to correlate environmental factors with behavioral outcomes.

The graphical user interface (GUI) of the system provides intuitive visualization of real-time video streams, behavioral annotations, and statistical summaries. Users can review session data, adjust analysis parameters, and export standardized datasets directly from the GUI. The visualization module supports 2D and 3D playback of reconstructed poses and trajectories, enabling efficient behavioral validation and reporting.

In yet another embodiment, the invention includes a confidence estimation and model fusion framework. The outputs from multiple neural models or camera sources are combined through probabilistic weighting to improve accuracy and reduce uncertainty. Confidence scores associated with each prediction are stored along with the behavioral features, enabling traceable validation of experimental outcomes.

Overall, the disclosed system provides a comprehensive, modular, and scalable platform for automated behavioral monitoring and analysis. By tightly coupling hardware-level data acquisition with advanced machine learning and standardized data management, the invention enables objective, reproducible, and translationally relevant behavioral phenotyping in preclinical research.

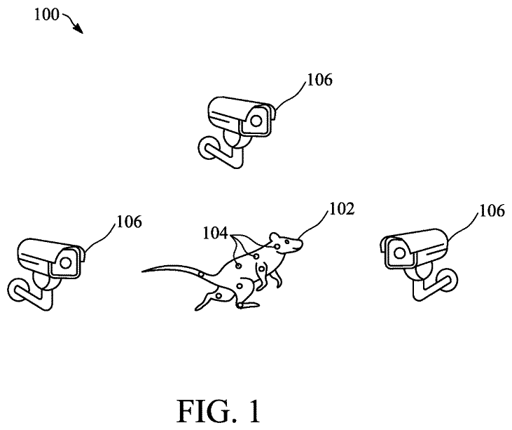

Referring now to FIG. 1, an environment diagram 100 where a system for real-time behavioural analysis of rodents is implemented, in accordance with an embodiment of the present disclosure. The environment diagram 100 illustrates a setup designed to continuously monitor and analyse the behaviour of a rodent 102 within a controlled environment.

At the center of the environment is a rodent 102, whose behaviour and movements are being tracked for analysis. The system is configured to monitor specific anatomical points 104 on the rodent, which include but are not limited to the head, body, tail, front paws, and back paws. These points are critical for capturing detailed motion data that reflects the rodent's physical activities and motor functions. Each anatomical point 104 is continuously tracked to monitor changes in the rodent's posture, movement, and overall behaviour, which is particularly relevant in studies involving neurological impairments such as strokes. Additionally, alternative embodiments may extend the applicability of the system to monitor rodents in models of other neurological conditions, including epilepsy or Parkinson's disease, by identifying distinct movement signatures associated with these disorders.

The environment is equipped with three cameras 106 strategically positioned around the rodent's enclosure to ensure comprehensive coverage of the rodent's movements from multiple angles. These cameras are designed to capture high-resolution video, allowing the system to accurately track the anatomical points 104 in real-time. The placement of the cameras ensures that even complex movements and interactions within the enclosure are captured without blind spots, enabling a detailed analysis of the rodent's behaviour.

A camera 106 is positioned above the enclosure, providing a top-down view that captures the overall layout and the rodent's movement patterns across the enclosure. Another camera 106 is positioned at a lateral angle, focusing on the side view of the rodent. This camera is particularly important for capturing lateral movements and detailed analysis of the rodent's gait and posture. Another camera 106 is positioned at the front, directly facing the rodent's primary area of activity, capturing frontal movements, and enabling detailed facial and head movement tracking.

The environment diagram 100 also suggests the integration of these cameras 106 with a real-time data processing system, which is not explicitly shown in this figure, but is crucial for the overall functionality. The video data captured by the cameras is transmitted to a central processing unit, where the system utilizes advanced algorithms to identify and track the anatomical points 104 in real-time. The system is capable of processing this data to generate various analytical outputs, such as movement trajectories, heatmaps, and 3D pose reconstructions.

While not explicitly labelled in FIG. 1, the environment is understood to simulate naturalistic conditions that are crucial for accurate behavioural analysis. This includes controlled lighting conditions, both standard and infrared, which enable continuous monitoring during both light and dark cycles. The enclosure is also equipped with elements such as built-in shelters, food, and water stations, ensuring that the rodent's behaviour is observed in a setting that closely mimics its natural environment.

The configuration depicted in FIG. 1 is designed to support a wide range of preclinical studies, particularly those focusing on neurological disorders such as stroke. Additionally, alternative embodiments may extend the applicability of the system to monitor rodents in models of other neurological conditions, including epilepsy or Parkinson's disease, by identifying distinct movement signatures associated with these disorders. By continuously tracking the anatomical points 104 of the rodent 102, researchers can gather detailed behavioural data, which can be correlated with other physiological data, such as MRI scans, to gain deeper insights into the effects of neurological impairments.

In summary, FIG. 1 illustrates a sophisticated environment setup where a rodent 102 is continuously monitored using three cameras 106, with a focus on tracking specific anatomical points 104 in real-time. This setup is integral to the system's ability to provide detailed behavioural analysis, which is essential for advancing research in neurological health.

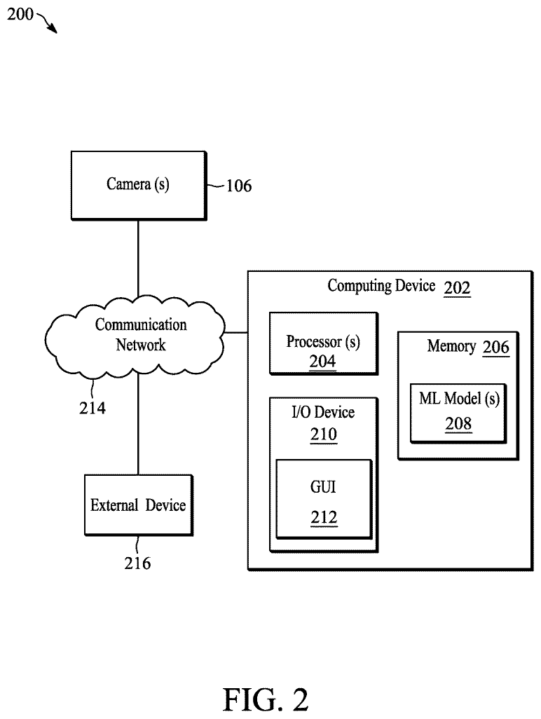

Referring now to FIG. 2, a block diagram of a real-time data processing system 200 for real-time behavioural analysis of the rodent 102 is illustrated, in accordance with an embodiment of the present disclosure. This real-time data processing system 200 is designed to enable the continuous and automated monitoring, analysis, and interpretation of rodent behaviours, particularly in preclinical studies where understanding the effects of neurological conditions like stroke is critical. Additionally, alternative embodiments may extend the applicability of the system to monitor rodents in models of other neurological conditions, including epilepsy or Parkinson's disease, by identifying distinct movement signatures associated with these disorders.

The real-time data processing system 200 may include a computing device 202, three cameras 106, and an external device 216 communicably coupled to each other through a wired or wireless communication network 214. The central component of the real-time data processing system 200 is the computing device 202, which orchestrates the real-time data processing tasks. The computing device 202 includes several key sub-components that enable it to perform these tasks efficiently. The computing device 202 may include a processor 204, a memory 206, and an input/output (I/O) device 210. The processor 204 is responsible for executing the instructions stored in the memory 206.

In an embodiment, examples of processor(s) 204 may include, but are not limited to, an Intel® Itanium® or Itanium 2 processor(s), or AMD® Opteron® or Athlon MP® processor(s), Motorola® lines of processors, Nvidia®, FortiSOC™ system on a chip processors, or other future processors. The processor 204 is equipped to execute complex algorithms, including those for tracking the anatomical points 104 on the rodent 102. In an embodiment, the processor 204 may be equipped to execute complex algorithms, including those for tracking anatomical points 104 on a subject. In an embodiment, the subject may be any living organism. The processor 204 may further process video feeds from the cameras 106 and run machine learning models stored in the memory 206. It manages the entire data pipeline from raw video capture to the final output, ensuring that all processes are completed within the time constraints necessary for real-time analysis.

In an embodiment, the memory 206 stores the instructions and data required for the processor 204 to execute its tasks. The memory 206 can be either non-volatile or volatile. Non-volatile memory types include flash memory, Read Only Memory (ROM), Programmable ROM (PROM), Erasable PROM (EPROM), and Electrically EPROM (EEPROM). Volatile memory types include Dynamic Random Access Memory (DRAM) and Static Random-Access Memory (SRAM).

In an embodiment, the memory 206 stores a machine learning model 208. This model is specifically designed to analyse the behavioural data captured from the rodent 102. The machine learning model 208 could be trained on a variety of behavioural datasets to predict and classify different types of movements and behaviours, such as those associated with neurological impairments. The memory 206 also stores historical data, system logs, and other relevant datasets that may be needed for comparative analysis or further processing.

The I/O device 210 serves as the interface between the computing device 202 and the external environment, allowing users to input commands and receive outputs. This device may include a variety of interfaces, such as those for keyboards, mice, touchscreens, and other data input/output devices. In particular, the I/O device 210 may include a Graphic User Interface (GUI) 212, which allows users to interact with the real-time data processing system 200 in an intuitive and user-friendly manner.

The GUI 212 is designed to facilitate the input of commands, the configuration of experiments, and the visualization of results. It allows users to monitor the system's performance, adjust settings, and review the data being processed in real-time. In some embodiments, the I/O device 210 may be wirelessly connected to the computing device 202 via interfaces such as Bluetooth®, infrared, or any other wireless radio communication known in the art.

In an embodiment, the external device 216 represents additional hardware or software tools that may be used in conjunction with the real-time data processing system 200. This could include devices for data input, external databases, or other systems involved in the regulatory submission process.

As mentioned, the machine learning model 208 stored in the memory 206 plays a pivotal role in analysing the behavioural data of the rodent 102. This model is trained on large datasets that include various behaviours exhibited by rodents under different conditions. The model can identify and classify behaviours in real-time, making it possible to detect subtle changes that may indicate neurological damage or recovery.

The machine learning model 208 is also capable of continuous learning, meaning it can adapt to new data and improve its accuracy over time. This capability is particularly useful in longitudinal studies where the rodent's behaviour might change gradually, and the real-time data processing system 200 needs to remain sensitive to these changes.

The real-time data processing system 200 includes three cameras 106 strategically positioned to capture comprehensive video data of the rodent 102 within its environment. These cameras are crucial for the continuous monitoring and analysis of the rodent's behaviour. Each camera 106 is positioned to cover different angles of the rodent's enclosure, ensuring that no movement goes untracked. For instance, one camera may be placed overhead to provide a top-down view of the entire enclosure, while the other two may be placed laterally at different heights to capture side views. This multi-angle coverage is essential for accurately tracking the anatomical points 104 on the rodent's body. The cameras 106 are equipped with high-resolution sensors that can capture detailed video data, even in low-light conditions. This capability is particularly important when studying rodents during their active nocturnal periods. The cameras are also synchronized to ensure that the video feeds can be accurately combined and analysed in real-time.

The video data captured by the camera 106 is transmitted to the computing device 202, where it is processed to identify and track the anatomical points 104 on the rodent 102. These points include the head, body, tail, front paws, and back paws, which are critical for understanding the rodent's movements and behaviours.

In an embodiment, the communication network 214 may be a wired or a wireless network or a combination thereof. The communication network 214 can be implemented as one of the different types of networks, such as but not limited to, Ethernet IP network, intranet, local area network (LAN), wide area network (WAN), the internet, Wi-Fi, LTE network, CDMA network, 5G, and the like. Further, the communication network 214 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the communication network 214 can include a variety of network devices, including routers, bridges, servers, computing devices, storage devices, and the like.

The external device 216 represents additional hardware or software tools that may be used in conjunction with the real-time data processing system 200. This device could be a mobile phone, tablet, laptop, or any other computing system that interacts with the computing device 202 via the communication network 214. The external device 216 can be used to control and configure the real-time data processing system 200 remotely. For instance, a researcher might use a tablet to start or stop data collection, adjust camera settings, or review preliminary results. The external device 216 can also be used to input data, access external databases, or interface with other systems involved in the regulatory submission process.

Communication between the external device 216 and the computing device 202 is facilitated through the communication network 214. This network could be a wired or wireless network, including technologies like Wi-Fi, Bluetooth®, or cellular networks. The seamless interaction between these devices ensures that the real-time data processing system 200 can be controlled and monitored from virtually any location, providing researchers with the flexibility to conduct experiments and analyse data in real-time, even when they are not physically present in the laboratory.

In an embodiment, the computing device 202 may receive a user input for real-time behavioural analysis of the rodent 102 from the external device 216 through the communication network 214. In an embodiment, the computing device 202 and the external device 216 may be a computing system, including but not limited to a smartphone, a laptop computer, a desktop computer, a notebook, a workstation, a portable computer, a handheld, a scanner, or a mobile device. In an embodiment, the computing device 202 may be, but not limited to, in-built into the external device 216 or may be a standalone computing device.

In an embodiment, the computing device 202 may perform various processes in order to analyse the behaviour of the rodent 102 in real-time. By way of an example, the real-time data processing system 200 is designed to perform real-time behavioural analysis of the rodent 102 by leveraging the components described above. The process begins with the camera 106 capturing video data of the rodent 102 as it moves within its enclosure. This data is transmitted to the computing device 202, where the processor 204 processes the video feeds to identify and track the anatomical points 104 on the rodent's body.

The processor 204 uses the instructions stored in the memory 206, including the machine learning model 208, to analyse the tracked points and identify patterns of behaviour. For example, the system can detect changes in the rodent's gait, posture, or activity levels, which may indicate the onset of neurological impairments. The machine learning model 208 plays a crucial role in this analysis by classifying different behaviours and predicting potential outcomes based on historical data.

The results of the analysis are then displayed to the user via the GUI 212 on the I/O device 210. The user can interact with the real-time data processing system 200 through the GUI 212 to view detailed reports, adjust settings, or input additional data. The real-time data processing system 200 may also generate alerts or notifications if certain behaviours are detected, allowing researchers to take immediate action if necessary.

In some cases, the results of the analysis may be transmitted to the external device 216, where they can be further reviewed or integrated with other data. The external device 216 can also be used to control the real-time data processing system 200 remotely, providing researchers with the flexibility to conduct experiments from virtually any location.

The real-time data processing system 200 described in FIG. 2 can be implemented in various embodiments, depending on the specific needs of the research or clinical study. Some of these embodiments are detailed below.

In one embodiment, the machine learning model 208 stored in the memory 206 could be enhanced with additional features, such as deep learning algorithms that can automatically adapt to new data and improve their predictive accuracy over time. These models could be trained on larger datasets, including data from multiple rodents, to improve their ability to generalize across different conditions.

In another embodiment, the cameras 106 could be upgraded to include advanced features such as 3D imaging, infrared sensors, or higher frame rates. These enhancements would allow the real-time data processing system 200 to capture more detailed data, particularly in low-light conditions or during rapid movements. The addition of 3D imaging could also enable more accurate tracking of the anatomical points 104, leading to better analysis of complex behaviours.

In yet another embodiment, the real-time data processing system 200 could be integrated with other systems, such as MRI or EEG machines (not shown), to provide a more comprehensive analysis of the rodent's behaviour. This integration could allow researchers to correlate behavioural data with physiological data, leading to deeper insights into the effects of neurological conditions.

In some embodiments, the real-time data processing system 200 could leverage cloud-based data processing to handle larger datasets or more complex analyses. By offloading some of the computational tasks to the cloud, the real-time data processing system 200 could provide faster results and scale to accommodate multiple experiments simultaneously.

The process flow of the real-time data processing system 200, as illustrated in FIG. 2, outlines the sequential steps and interactions between the various components of the system, aimed at performing real-time behavioural analysis of a rodent 102. This real-time data processing system 200 is designed to continuously track and analyse the rodent's behaviour using video data, ultimately providing insights into neurological conditions or the effects of various treatments.

The process begins with the camera 106 capturing video data of the rodent 102 within its enclosure. The real-time data processing system 200 employs three cameras positioned to cover different angles, ensuring comprehensive coverage of the rodent's movements. These cameras are set up to capture high-resolution video in real-time, which is essential for detailed tracking of the rodent's anatomical points, including the head, body, tail, front paws, and back paws.

The cameras are activated and begin recording video data as the rodent moves within its environment. The video feeds from the cameras 106 are continuously transmitted to the computing device 202 over the communication network 214.

Once the video data reaches the computing device 202, the real-time data processing system 200 initiates the data processing phase. The processor 204 within the computing device 202 is responsible for handling this data. The computing device 202 receives the video streams from the cameras 106. The processor 204 starts processing the incoming video data, focusing on identifying and tracking the anatomical points of the rodent.

The primary function of the processor 204 is to execute the instructions stored in the memory 206 to track the rodent's movements in real-time. This involves detecting and continuously monitoring the specified anatomical points. The processor 204 identifies key anatomical points on the rodent's body in the video frames, such as the head, body, tail, and paws.

The real-time data processing system 200 tracks these points across subsequent video frames, mapping the rodent's movement patterns. As the tracking data accumulates, the real-time data processing system 200 analyses the rodent's behaviour. This includes identifying movement patterns, changes in activity levels, and other relevant behavioural metrics. The machine learning model 208, stored in the memory 206, plays a critical role in the analysis process. It is applied to the tracked data to classify and interpret the rodent's behaviours. The processor 204 executes the machine learning model 208 on the tracked data. This model is designed to recognize patterns in the rodent's behaviour, making predictions or classifications based on the input data. The model classifies the rodent's actions, such as walking, resting, grooming, or exploring. These classifications are essential for understanding the rodent's behaviour in relation to the experimental conditions.

After processing and analysis, the results are prepared for user interaction. The system utilizes the Input/Output (I/O) device 210, particularly the Graphic User Interface (GUI) 212, to present the findings. The results of the behavioural analysis are visualized on the GUI 212. This interface allows the user to review the rodent's behaviour in real-time, with options to view specific metrics, graphical representations, or raw data. Users can interact with the real-time data processing system 200 through the GUI 212, adjusting parameters, reviewing data, and controlling the analysis process as needed. The interface is designed to be intuitive, providing quick access to important functions and data.

The real-time data processing system 200 allows for external device 216 interaction through the communication network 214. The external device 216 can access the computing device 202 to control the real-time data processing system 200 or review the analysis results remotely. The analysis results can be shared with the external device 216, which could be a smartphone, tablet, or other computing device. Users can use the external device 216 to remotely control the real-time data processing system 200, adjusting settings, initiating or stopping analysis, and reviewing data without needing to be physically present at the location of the computing device 202.

The real-time data processing system 200 is designed for continuous monitoring of the rodent's behaviour. This involves a feedback loop where the data from previous analyses can influence ongoing monitoring. The cameras 106 continue to capture video data, ensuring that no behaviour goes unrecorded. The processor 204 constantly updates the analysis as new data is received, ensuring that the behaviour classification is always up-to-date. The results of the current analysis can be used to refine future data processing, enhancing the system's ability to detect and classify behaviours accurately over time.

The process flow of the real-time data processing system 200 is a highly integrated sequence of steps that enables the continuous and automated monitoring of rodent behaviour. From video data capture to real-time behavioural analysis and user interaction, the real-time data processing system 200 provides a comprehensive solution for studying the effects of neurological conditions or treatments on rodents in preclinical settings. Each component of the real-time data processing system 200 plays a critical role in ensuring that the data is processed efficiently, the analysis is accurate, and the results are accessible to researchers for further study or immediate action.

The real-time data processing system 200 described in FIG. 2 is a powerful tool for the behavioural analysis of rodents, particularly in preclinical studies focused on neurological conditions. By combining advanced video tracking, machine learning, and real-time data processing, the real-time data processing system 200 enables researchers to monitor and analyse rodent behaviour with unprecedented accuracy and detail. Whether implemented in its basic form or enhanced with additional features, this real-time data processing system 200 has the potential to significantly advance our understanding of neurological disorders and improve the development of new treatments.

As will be appreciated by one skilled in the art, a variety of processes may be employed for real-time behavioural analysis of rodents. For example, the exemplary real-time data processing system 200 and the associated computing device 202 may perform real-time behavioural analysis of rodents by the processes discussed herein. In particular, as will be appreciated by those of ordinary skill in the art, control logic and/or automated routines for performing the techniques and steps described herein may be implemented by the real-time data processing system 200 and the associated computing device 202 either by hardware, software, or combinations of hardware and software. For example, suitable code may be accessed and executed by the one or more processors on the real-time data processing system 200 to perform some or all of the techniques described herein. Similarly, application-specific integrated circuits (ASICs) configured to perform some or all of the processes described herein may be included in the one or more processors on the real-time data processing system 200.

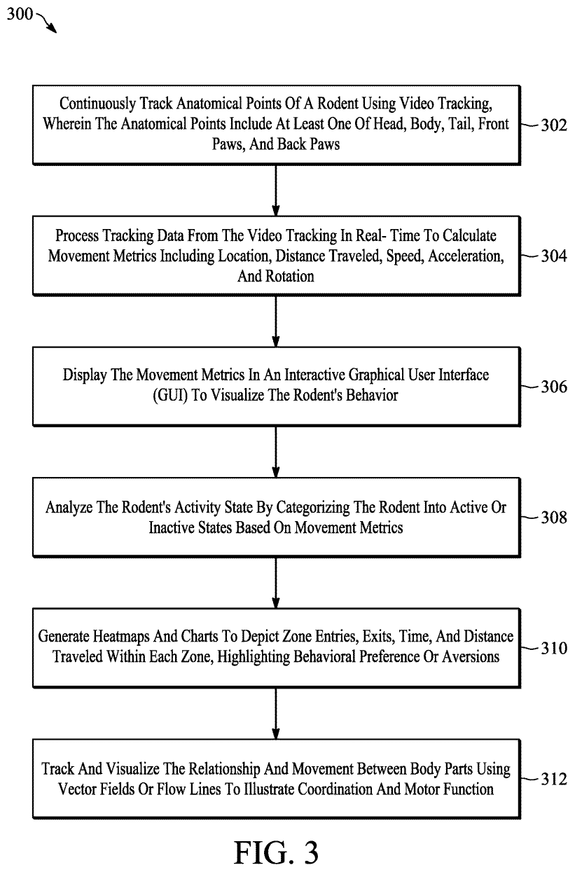

Referring now to FIG. 3, a flow diagram of a method 300 for real-time behavioural analysis of the rodent 102, in accordance with an embodiment of the present disclosure. In an embodiment, the method 300 may include a plurality of steps that may be performed by the real-time data processing system 200 to track, analyse, and interpret the behaviour of the rodent 102 in real-time. FIG. 3 is explained in conjunction with FIGS. 1 and 2, ensuring that the real-time data processing system 200 functions cohesively to provide accurate behavioural insights. This description will explain each step of the method 300 in detail, highlighting the interactions between various elements of the real-time data processing system 200.

At step 302, the process begins with the continuous tracking of anatomical points on the rodent 102 using video tracking technology. These anatomical points include at least one of the head, body, tail, front paws, and back paws. High-resolution cameras 106 capture real-time video footage of the rodent, and tracking algorithms are applied to identify and monitor the specified anatomical points. The real-time data processing system 200 ensures that the tracking is consistent and accurate, capturing the rodent's movements in its entirety.

Further, at step 304, the tracking data obtained from the video footage is processed in real time to calculate movement metrics. These metrics include location, distance travelled, speed, acceleration, and rotation. The data processing involves extracting relevant movement information from the video frames and calculating various metrics that provide insights into the rodent's behaviour. This real-time processing ensures that the data is current and reflects the rodent's immediate activity.

Further, at step 306, the calculated movement metrics are displayed on an interactive graphical user interface (GUI) 212 to visualize the rodent's behaviour. The GUI 212 provides a user-friendly platform where researchers can view and interact with the movement metrics. Visualizations such as graphs, charts, and maps are generated to represent the data effectively, allowing researchers to monitor the rodent's behaviour in real time.

Further, at step 308, the rodent's activity state is analysed by categorizing its behaviour into active or inactive states based on the movement metrics. The real-time data processing system 200 uses predefined criteria to determine when the rodent is considered active or inactive. This categorization helps in understanding the rodent's overall activity levels and behavioural patterns. A timeline and pie charts of the proportion of time spent in active versus inactive states are presented on the GUI 212. The GUI 212 displays visual representations such as timelines and pie charts to illustrate the distribution of the rodent's time across active and inactive states. This visual presentation aids in quickly assessing the rodent's behaviour over a specified period.

Further at step 310, heatmaps and line charts are generated to depict zone entries, exits, time, and distance travelled within each zone, highlighting behavioural preferences or aversions. Heatmaps visualize the intensity and frequency of the rodent's presence in different zones, while line charts track the time spent and distance travelled within each zone. These visualizations help in identifying areas of preference or avoidance, providing insights into the rodent's spatial behaviour.

Further, at step 312, the relationship and movement between different body parts of the rodent are tracked and visualized using vector fields or flow lines. Vector fields or flow lines are used to illustrate the coordination and motor function of the rodent by showing the movement patterns between anatomical points. This analysis helps in understanding how different body parts interact and function together, providing a deeper insight into the rodent's motor control.

The method 300, as illustrated in FIG. 3, provides a comprehensive approach to real-time behavioural analysis of rodents. By continuously tracking anatomical points, processing movement data, and presenting it through interactive visualizations, the method enables detailed and actionable insights into rodent behaviour. The steps outlined in the flow diagram ensure that the real-time data processing system 200 delivers accurate, real-time data, facilitating effective analysis and interpretation of rodent behaviour for research purposes.

The flow diagram of method 300 in FIG. 3 represents a comprehensive process for real-time behavioural analysis of a rodent. Each step of the method is intricately connected to the components described in FIGS. 1 and 2, ensuring that the real-time data processing system 200 operates seamlessly from data capture to user interaction. The method 300 leverages advanced image processing, machine learning, and real-time data analysis to provide researchers with valuable insights into rodent behaviour, making it a powerful tool for preclinical studies and neurological research.

Thus, the disclosed method 300 and the real-time data processing system 200 try to overcome the technical problem of effectively and accurately monitoring and analysing the real-time behavioural patterns of rodents in a continuous and automated manner. The technical problem addressed includes several key challenges.

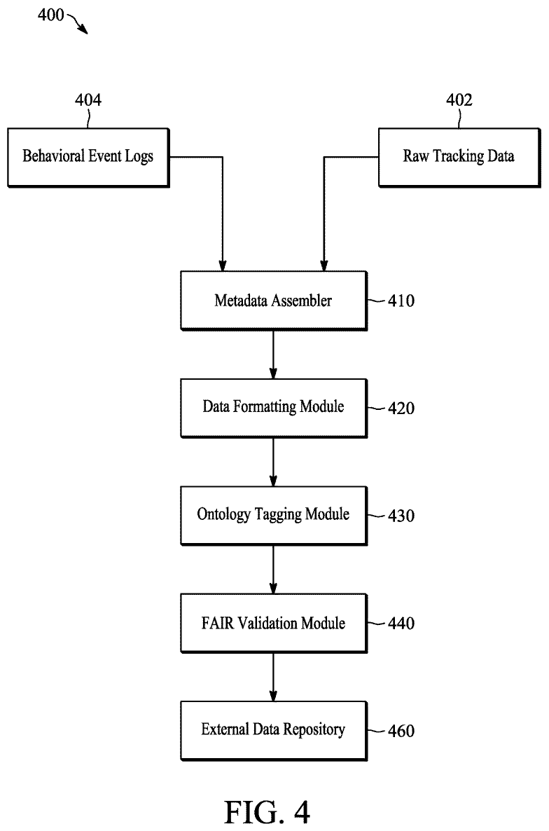

FIG. 4 illustrates an exemplary embodiment of a data standardization and the data export pipeline 400 incorporated within the behavioral analysis system described herein. The data export pipeline 400 ensures that all experimental data produced by the system are stored and transmitted in a FAIR-compliant, machine-readable manner consistent with the NIH Data Management and Sharing (DMS) policy. The data export pipeline 400 may be implemented as executable instructions on a processing unit or as hardware logic embedded within a data-management module of the system controller.

As shown in FIG. 4, the data export pipeline 400 receives raw tracking data 402 generated by a pose estimation engine and behavioral event logs 404 produced by a classifier module. Each record of raw tracking data 402 comprises a plurality of coordinate points (x, y, z) for each detected anatomical keypoint of the animal, along with a corresponding confidence value between 0 and 1. The behavioral event log 404 includes time-stamped annotations indicating detected behaviors such as grooming, rearing, and locomotion episodes.

The raw tracking data 402 and the behavioral event logs 404 are provided to a metadata assembler 410, which automatically associates experiment-specific descriptors with each frame or event. The descriptors include, for example, animal identifier, cage identifier, experiment protocol number, ambient light level, stimulus conditions, and acquisition timestamp. The metadata assembler 410 also records device specifications such as camera serial numbers, frame rate, and resolution, thereby enabling later reproducibility of the experimental setup.

The annotated dataset is then passed to a data formatting module 420, which converts the combined behavioral and metadata streams into structured data objects. In one embodiment, the data formatting module 420 generates files in JavaScript Object Notation (JSON) and Hierarchical Data Format 5 (HDF5), though other structured formats such as CSV or XML may be used. Each formatted data object includes a defined schema specifying field names, units, and ontology mappings.

The data export pipeline 400 further includes an ontology tagging module 430, which automatically inserts standardized biomedical vocabulary identifiers into the schema. The ontology tagging module 430 may access an internal or external vocabulary database containing terms from the Unified Medical Language System (UMLS), the National Institute of Neurological Disorders and Stroke (NINDS) Common Data Elements (CDEs), and other domain-relevant ontologies. For instance, behavioral metrics such as “stride length” or “paw contact duration” are assigned unique identifiers consistent with the referenced CDE entries.

Following ontology tagging, the formatted dataset is transmitted to a FAIR validation module 440. The FAIR validation module 440 comprises a plurality of sub-checkers configured to ensure that the dataset satisfies the four primary FAIR principles: (a) Findability, verified by generation of persistent digital object identifiers (DOIs) and index keys; (b) Accessibility, validated by storage of datasets in a repository-compatible container; (c) Interoperability, confirmed by file readability across standard analysis software such as Python, R, and MATLAB; and (d) Reusability, ensured by inclusion of descriptive metadata and documentation.

A repository interface communicates validated datasets to external data repositories 460, such as the National Data for Health and Clinical Collections (NDHCC) or laboratory-specific cloud archives. The repository interface may employ secure transmission protocols (e.g., HTTPS, SFTP) and generate logs documenting the date, time, and verification checksum for each data submission. The exported datasets are thereby rendered immediately repository-ready without additional post-processing steps.

Optionally, a versioning manager appends software and schema version numbers to each exported dataset to maintain traceability over time. The versioning manager may also store an internal record linking the dataset to the particular configuration of the behavioral analysis software used to generate it. This enables longitudinal comparison of data produced under differing model versions or algorithmic updates.

Through the described arrangement, FIG. 4 demonstrates how the behavioral analysis system produces fully structured, standardized, and ontology-linked data outputs that are compliant with FAIR and NIH DMS standards. This architecture eliminates the need for manual curation or conversion of raw data, ensures transparency and reproducibility, and facilitates immediate integration of the resulting datasets into community repositories and regulatory submissions.

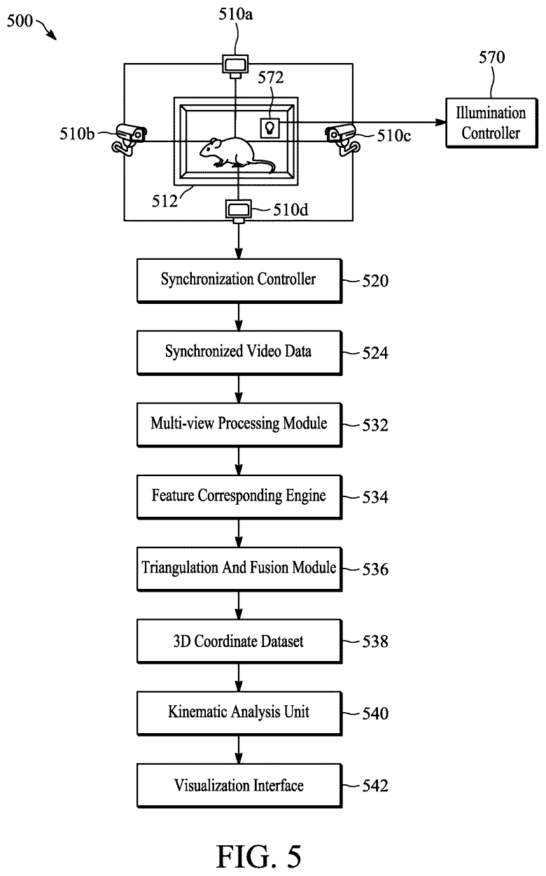

FIG. 5 illustrates an exemplary embodiment of a multi-camera 3D reconstruction system 500 that forms a part of the overall behavioral analysis apparatus. The multi-camera 3D reconstruction system 500 enables synchronized acquisition of multiple views of the subject animal to generate a high-fidelity, three-dimensional (3D) kinematic model of body motion and posture. The multi-camera 3D reconstruction system 500 may be deployed in open-field arenas, ladder-walk platforms, or home-cage environments and operates in conjunction with the core processing and tracking modules described with respect to FIGS. 1-4.

As shown in FIG. 5, the multi-camera 3D reconstruction system 500 includes a plurality of imaging units, each comprising a digital camera configured to capture video frames of the animal from different orientations. In one embodiment, the array includes a top-mounted camera 510a, side-mounted cameras 510b and 510c, and an underneath camera 510d positioned below a transparent cage floor 512. The underneath camera 510d provides direct visualization of paw placement, toe spread, and contact timing, which are typically obscured in single-view systems.

Each imaging unit is coupled to a synchronization controller 520 through a wired or wireless communication bus. The synchronization controller 520 distributes timing pulses to ensure that all cameras capture frames within a defined temporal window (e.g., within 2 ms). The synchronization controller 520 may also embed a common timestamp and frame index into each video stream to facilitate subsequent alignment.

The synchronized video data 524 are transmitted to a multi-view processing module 532, which performs temporal alignment and geometric calibration. The multi-view processing module 532 utilizes pre-calibrated intrinsic and extrinsic parameters for each camera and computes projection matrices mapping pixel coordinates to a global 3D coordinate space. Calibration markers or fiducial grids placed within the arena enable automatic correction of lens distortion and spatial orientation.

The system further comprises a feature correspondence engine 534 that identifies matching anatomical keypoints across the multiple camera views. The feature correspondence engine 534 receives 2D keypoint detections from a pose estimation network and employs epipolar geometry to match corresponding keypoints between views. When keypoints are temporarily occluded in one view, a Kalman filter estimates their probable positions based on prior motion trajectories and velocity vectors.

The matched keypoints are subsequently passed to a triangulation and fusion module 536, which reconstructs the 3D position of each anatomical landmark. The fusion module 536 employs linear least-squares triangulation and temporal smoothing to reduce jitter. In certain embodiments, dynamic time warping is applied to align limb trajectories across frames and correct for sub-frame timing differences. The resulting 3D coordinate dataset 538 represents the animal's full-body skeletal motion at sub-millimeter spatial resolution.

A kinematic analysis unit 540 derives quantitative gait and posture metrics from the reconstructed 3D trajectories. Example parameters include stride length, paw spacing, duty cycle, step symmetry, center-of-mass displacement, and balance oscillation. The kinematic analysis unit 540 outputs these metrics to a classifier module and to a visualization interface 542, which displays a dynamically rendered 3D skeleton overlay on video footage for user verification.

In some embodiments, the multi-camera 3D reconstruction 500 further integrates an illumination controller 570 for coordinated lighting management. The illumination controller 570 regulates infrared (IR) and visible light sources 572 to maintain uniform illumination while minimizing behavioral interference. The controller may dynamically adjust light intensity based on camera exposure feedback, thereby preserving image consistency across all viewing angles.

The reconstructed 3D models generated by the multi-camera 3D reconstruction system 500 are stored within the data export pipeline 400 (see FIG. 4) for downstream FAIR-compliant formatting and repository submission. By combining multi-view geometry, Kalman-based temporal fusion, and synchronization control, the multi-camera 3D reconstruction system 500 provides robust, high-accuracy 3D behavioral data suitable for fine-grained biomechanical and neurological analysis.

Accordingly, FIG. 5 demonstrates an integrated multi-camera arrangement that overcomes the limitations of single-camera 2D tracking by providing depth-aware reconstruction of limb motion and posture. The resulting dataset enables precise quantification of complex motor patterns, including gait asymmetry, balance shifts, and compensatory limb coordination following injury or therapeutic intervention.

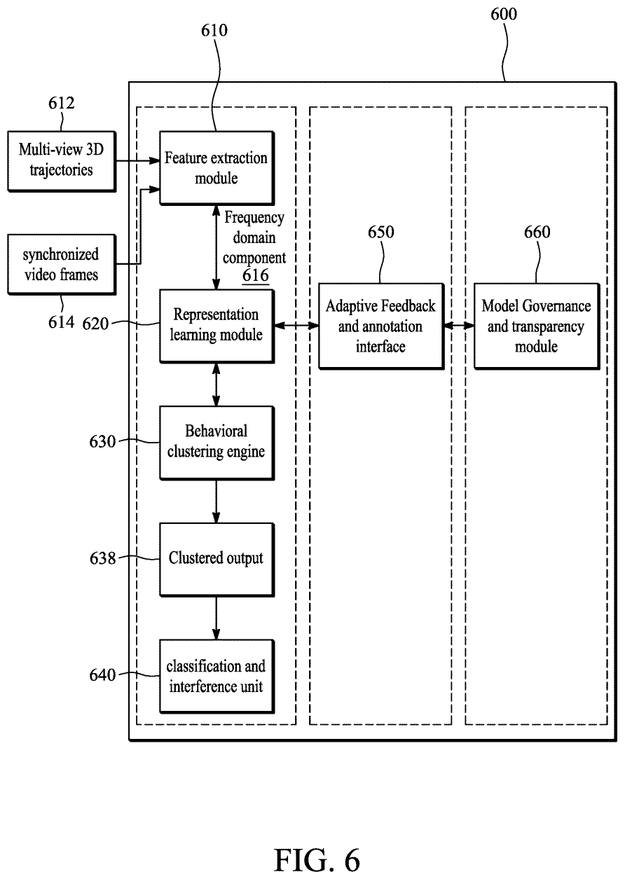

FIG. 6 illustrates an exemplary embodiment of an advanced machine learning and behavior discovery system 600 configured to automatically classify, discover, and quantify behavioral motifs of the subject animal using both supervised and unsupervised computational pipelines. The behavior discovery system 600 operates in conjunction with the multi-camera 3D reconstruction 500 of FIG. 5 and the data export pipeline 400 of FIG. 4, thereby forming a comprehensive analytics layer for behavioral understanding.

As shown in FIG. 6, the behavior discovery system 600 comprises a feature extraction module 610, a representation learning module 620, a behavioral clustering engine 630, and a classification and inference unit 640, all of which are implemented through a set of processors, GPUs, or neural-accelerator hardware. The system further includes an adaptive feedback and annotation interface 650 to enable iterative human-in-the-loop refinement.

The feature extraction module 610 receives input in the form of multi-view 3D trajectories 612 and synchronized video frames 614 generated by the multi-camera 3D reconstruction system 500. The feature extraction module 610 computes a high-dimensional set of kinematic and dynamic parameters, including velocity vectors, joint angles, inter-limb phase relationships, curvature of the spinal axis, and paw-ground contact durations. Additional derived features such as kinetic energy, acceleration magnitude, and frequency-domain components 616 are generated using Fourier transforms or wavelet decompositions. These quantitative descriptors form the initial representation for subsequent learning stages.

The representation learning module 620 transforms the extracted features into a latent embedding space that captures the underlying structure of behavioral sequences. In one embodiment, the representation learning module 620 implements a convolutional neural network (CNN) trained on annotated examples of locomotion, grooming, and exploratory behaviors. In another embodiment, a temporal transformer network encodes sequential dependencies over long durations, utilizing self-attention weights to emphasize motion segments of high discriminative value. The latent embedding space produced by the module is normalized and dimension-reduced using principal component analysis (PCA) or t-distributed stochastic neighbor embedding (t-SNE) to yield a compact manifold suitable for clustering.

The behavioral clustering engine 630 performs unsupervised grouping of behavior sequences to identify recurring motifs without requiring prior labels. In certain implementations, the behavioural clustering engine 630 employs a hierarchical Dirichlet process-hidden Markov model (HDP-HMM) that automatically determines the number of latent behavioral states based on the statistical properties of the input data. The engine may also incorporate a Gaussian mixture model (GMM) or density-based spatial clustering (DBSCAN) to separate behavior modes with distinct temporal or kinematic signatures. The resulting clustered output 638 corresponds to discrete behavioral motifs such as rearing, sniffing, grooming, feeding, or rest, which are mapped to corresponding time intervals in the video dataset.

The clustered outputs 638 are further analyzed by the classification and inference unit 640, which assigns semantic labels to each behavioral segment and computes associated confidence scores. The unit 640 maintains a behavioral ontology database linking each recognized behavior to defined metrics, anatomical involvement, and possible neurological correlates. The classification and interference unit 640 may also fuse multiple inference models, including support-vector machines (SVMs), random forests, and recurrent neural networks (RNNs), into an ensemble predictor to enhance robustness under variable lighting or occlusion conditions.

In one embodiment, the classification and interference unit 640 is configured to compute an activity coordination index (ACI), which quantifies the temporal synchrony and sequential transitions between different behaviors. The ACI can be employed to evaluate the effects of pharmacological interventions or neuro-modulatory treatments on behavior organization. For example, decreased inter-limb coordination or abnormal transition probabilities between gait and rest behaviors may indicate cerebellar or motor-cortex dysfunction.

The adaptive feedback and annotation interface 650 allows researchers to visualize discovered clusters in an interactive 2D or 3D embedding map. Each cluster point corresponds to a behavioral episode, color-coded by inferred class or confidence. The interface supports manual relabeling, merging, or splitting of clusters, and such edits are stored as metadata in the FAIR data repository. The interface further enables on-the-fly retraining of the models using active learning strategies, whereby uncertain samples are prioritized for annotation to accelerate convergence.

The behavior discovery system 600 also integrates a model governance and transparency module 660 that records all training parameters, hyper-settings, and dataset identifiers, ensuring reproducibility of derived models. The transparency module 660 may automatically generate training reports compliant with FAIR principles, including versioning, provenance, and explainability metadata.

By leveraging both supervised and unsupervised learning paradigms, the behavior discovery system 600 enables the autonomous discovery of novel behavioral motifs beyond pre-defined human categories. The resultant multi-level representation allows researchers to perform high-resolution behavioral phenotyping and identify subtle motor or affective alterations induced by genetic, pharmacological, or environmental factors. The use of deep representation learning coupled with HDP-based unsupervised modeling provides the ability to generalize across species, strains, and experimental setups.

Accordingly, FIG. 6 provides an integrated framework for advanced behavioral discovery that combines interpretable feature generation, deep embedding representation, and transparent classification, resulting in scalable, repeatable, and unbiased behavioral analytics suitable for translational neuroscience research.

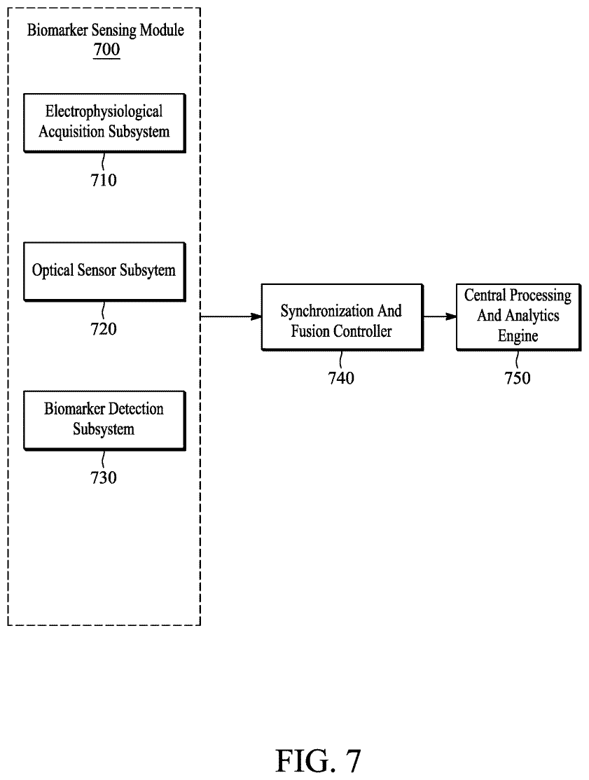

FIG. 7 illustrates an exemplary embodiment of a physiological and biomarker sensing module 700 integrated within the behavioral analysis system. The biomarker sensing module 700 enables multimodal measurement of the animal's physiological states and biochemical markers in synchronization with behavioral and kinematic data, thereby providing a unified platform for correlating neurophysiological responses with observable actions.

As shown in FIG. 7, the biomarker sensing module 700 comprises a plurality of sensing subsystems, including an electrophysiological acquisition subsystem 710, an optical or optical sensor subsystem 720, a biochemical or biomarker detection subsystem 730, and a synchronization and fusion controller 740. Each subsystem is communicatively linked to the central processing and analytics engine 750 via a data integration bus.

The electrophysiological acquisition subsystem 710 is configured to record bioelectrical signals indicative of central and peripheral nervous activity. In one embodiment, the electrophysiological acquisition subsystem 710 includes implantable microelectrode arrays positioned at targeted brain regions such as the motor cortex, hippocampus, or cerebellum. In another embodiment, surface or subcutaneous electrodes are positioned along the peripheral nervous pathways or muscle groups to record electromyographic (EMG) signals. The recorded potentials are amplified by a low-noise amplifier circuit and digitized through an analog-to-digital converter (ADC), producing high-resolution neural time series data.

The optical sensor subsystem 720 comprises one or more non-invasive sensors configured to monitor hemodynamic, metabolic, or fluorescent signals. In one embodiment, the optical sensor subsystem includes fiber-coupled photometric probes capable of detecting calcium or voltage indicators (e.g., GCaMP, RCaMP). In another embodiment, a near-infrared spectroscopy (NIRS) sensor measures blood oxygenation and hemoglobin concentration variations. The subsystem 720 may further incorporate a thermal imaging camera or infrared photodiodes for detecting surface temperature fluctuations and breathing rhythms. The optical sensors are controlled by a light modulation driver that synchronizes illumination and acquisition cycles with the behavioral imaging system described in FIG. 5.

The biochemical or biomarker detection subsystem 730 is adapted to detect chemical and molecular indicators correlated with physiological or pathological conditions. In one implementation, the optical sensor subsystem 720 includes a microfluidic sampling cartridge integrated into the cage floor or feeding port, capable of collecting saliva, sweat, or microdroplets for biochemical analysis. The collected sample is analyzed using biosensor arrays that employ enzyme-based, aptamer-based, or impedance-based transduction. In another configuration, a volatile compound sensor measures exhaled gases such as ammonia, ethanol, or acetone to assess metabolic activity. The outputs from these biosensors are conditioned by a signal conditioning circuit before digital conversion.

The synchronization and fusion controller 740 ensures temporal alignment among all sensing modalities. The fusion controller 740 incorporates a timestamp generator synchronized with the video and 3D motion capture subsystems (see FIGS. 4 and 5). The controller may execute a cross-modality alignment algorithm, which uses correlation-based signal matching to correct timing offsets between electrophysiological spikes, hemodynamic fluctuations, and behavior onset events. The aligned data streams are merged into a unified multimodal data frame, formatted according to FAIR metadata standards for reproducibility and downstream analysis.

The central processing and analytics engine 750 performs higher-order integration of the multimodal signals. The engine includes a multimodal correlation module configured to compute statistical associations between neural firing patterns and behavioral motifs discovered by the system of FIG. 6. The engine may further comprise a causal inference model, such as a Granger causality estimator or dynamic Bayesian network, to infer directed influence between physiological events and behavioral outcomes. A time-frequency analysis unit may be employed to extract power spectral densities of neural oscillations and relate them to periodic motor actions.

In one embodiment, the analytics engine 750 generates a physio-behavioral map that visualizes the temporal alignment between neural activity, hemodynamic changes, and behavioral episodes such as grooming or locomotion. The physio-behavioral map may be displayed through a graphical interface, enabling researchers to explore time-synchronized plots, heatmaps, and causal overlays. Each map instance may be exported in a standardized format (e.g., Neurodata Without Borders or HDF5) for cross-laboratory data sharing.

The biomarker sensing module 700 may further include an adaptive calibration module, which automatically adjusts sensor gain, baseline, or sampling rate in response to signal drift or motion artifacts. For instance, if excessive motion noise is detected in the EMG signal, the system can momentarily increase the sampling frequency or apply a notch filter to preserve signal integrity. Calibration metadata are stored in an instrument configuration log for quality assurance.

In certain embodiments, the biomarker sensing module 700 interfaces with neuromodulation devices, such as transcranial magnetic stimulators or optogenetic light sources, to deliver targeted stimulation while monitoring behavioral and physiological responses in real time. The synchronization between stimulation onset and behavioral response provides a causal experimental framework for testing neural circuitry hypotheses.

By integrating electrophysiological, optical, and biochemical sensors into a unified architecture, the biomarker sensing module 700 provides a comprehensive view of the animal's internal state alongside its observable behavior. The multimodal integration enables identification of latent biomarkers, quantification of stress or arousal levels, and evaluation of treatment efficacy.

Accordingly, FIG. 7 demonstrates an extensible sensing platform that bridges neural and behavioral domains, supporting cross-scale investigation from molecular to systems-level neuroscience, and enhancing reproducibility and interpretability of behavioral studies.

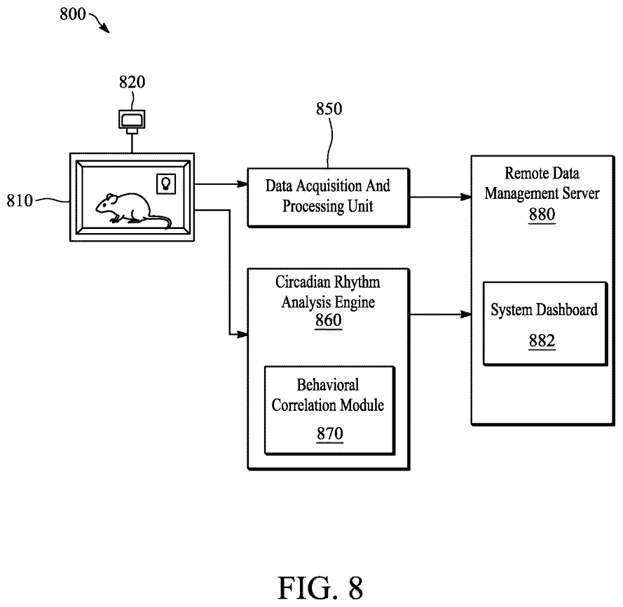

FIG. 8 illustrates an embodiment of a home/cage behavioral monitoring and circadian tracking system 800 configured for continuous, non-intrusive observation of one or more rodents over extended durations. The home/cage behavioral monitoring and circadian tracking system 800 enables longitudinal analysis of sleep-wake cycles, feeding behavior, nesting, locomotion, and social interaction within a naturalistic environment, while maintaining automated data acquisition and analysis through the central processing platform described in FIGS. 4 to 7.

As shown in FIG. 8, the home/cage behavioral monitoring and circadian tracking system 800 comprises a cage enclosure 810, one or more imaging and illumination subsystems 820, an environmental control subsystem, a sensor integration hub, a data acquisition and processing unit 850, and a circadian rhythm analysis engine 860. Each component communicates over a local or wireless network interface, facilitating synchronized data collection and adaptive control.

The cage enclosure 810 includes a base plate, transparent side walls, and a removable top cover that allows installation of overhead cameras or lighting units. The base plate may be constructed from a non-reflective polymer to minimize optical interference and may optionally incorporate pressure-sensitive zones or load cells beneath the bedding material to record weight shifts and locomotor activity patterns. A food dispensing unit, water spout, and nesting area are strategically positioned within the enclosure to encourage spontaneous behaviors relevant to circadian and metabolic studies.

The imaging and illumination subsystem 820 comprises a plurality of cameras 106 oriented to provide multi-view coverage, including top, lateral, and oblique perspectives. Each camera 106 is equipped with a dual-mode optical system capable of switching between visible and infrared (IR) imaging modes. In one embodiment, IR illumination diodes or low-intensity red LEDs are installed along the cage perimeter to enable nocturnal video capture without disrupting the rodents' dark-phase behavior. A light cycle controller modulates intensity and wavelength according to predefined circadian light-dark schedules, emulating natural day-night transitions.

The environmental control subsystem manages and records the cage's micro-environmental conditions. The subsystem includes one or more temperature sensors, humidity sensors, and airflow sensors, which continuously monitor the ambient parameters within the enclosure. A microclimate controller dynamically regulates these parameters via heating or ventilation elements to ensure stable conditions across extended experimental durations. Environmental readings are logged at regular intervals and synchronized with the behavioral data stream for contextual interpretation.

The sensor integration hub acts as an intermediary interface for additional behavioral and physiological sensors. The hub may receive input from RFID readers embedded beneath the floor plate for automatic animal identification, vibration sensors for detecting movement onset during sleep, and acoustic microphones for capturing ultrasonic vocalizations or ambient noise levels. Each sensor is connected to the hub controller, which timestamps incoming data and transmits it to the data acquisition and processing unit 850.

The data acquisition and processing unit 850 includes a high-performance embedded processor, a local storage module, and a network communication interface. The processor executes machine learning pipelines that perform real-time pose estimation, motion segmentation, and behavioral classification based on the camera streams and sensor inputs. In one embodiment, the processor is GPU-accelerated, enabling simultaneous processing of multiple cages. The data synchronization module ensures temporal coherence between multimodal data streams, aligning each behavioral event with corresponding environmental and temporal metadata. The system can store raw and processed data in FAIR-compliant formats such as HDF5 or JSON, embedding metadata tags in accordance with NIH Data Management and Sharing (DMS) standards.

The circadian rhythm analysis engine 860 is configured to detect and quantify rhythmic patterns in behavior and physiology across diurnal cycles. The engine includes a temporal pattern recognition module that applies signal decomposition techniques (e.g., Fourier or wavelet transforms) to extract periodicities in activity, feeding, and rest. A phase and amplitude computation unit determines onset and offset times of active phases, while a sleep-wake classifier distinguishes between rest, light sleep, and active wakefulness states using pose and motion features derived from the imaging subsystem. The results are compiled into circadian profiles, which may be visualized as actograms, heatmaps, or vector plots to represent rhythmic stability and entrainment.

In certain embodiments, the circadian rhythm analysis engine 860 incorporates a behavioral correlation module 870 that links circadian activity patterns to molecular or physiological markers captured by the sensing module of FIG. 7. For example, sleep fragmentation or altered activity onset may be statistically associated with specific biomarkers, such as elevated corticosterone levels or altered neural oscillatory power. The correlation outputs are stored within a cross-modal database for longitudinal tracking and predictive modeling.

The home/cage behavioral monitoring and circadian tracking system 800 further supports multi-animal monitoring within a shared enclosure. Each rodent is assigned a unique digital identity based on appearance features and motion trajectory embedding generated by a re-identification network. When multiple animals interact, the interaction analyzer computes proximity, following, or grooming events, which are tagged and time-aligned with the circadian phase, enabling contextual interpretation of social behaviors across light-dark transitions.

In one implementation, the home-cage architecture operates autonomously, with data streaming to a remote data management server 880 via a secure connection. The server may perform centralized quality control, detect anomalies such as camera drift or lighting inconsistencies, and issue automated calibration commands back to the cage controller. A system dashboard 882 provides live visualization of animal activity, environmental conditions, and system health metrics, accessible through a graphical interface on a connected computing device.

In operation, the home/cage behavioral monitoring and circadian tracking system 800 allows uninterrupted monitoring of rodents over days or weeks, capturing high-resolution temporal data reflective of natural circadian behavior. The combination of multi-spectral imaging, environmental sensing, and intelligent analysis modules ensures accurate quantification of behavioral states under undisturbed conditions. By integrating continuous data capture with FAIR-compliant data handling and automated circadian analysis, the home/cage behavioral monitoring and circadian tracking system 800 establishes a scalable, reproducible framework for longitudinal behavioral neuroscience and translational pharmacology.

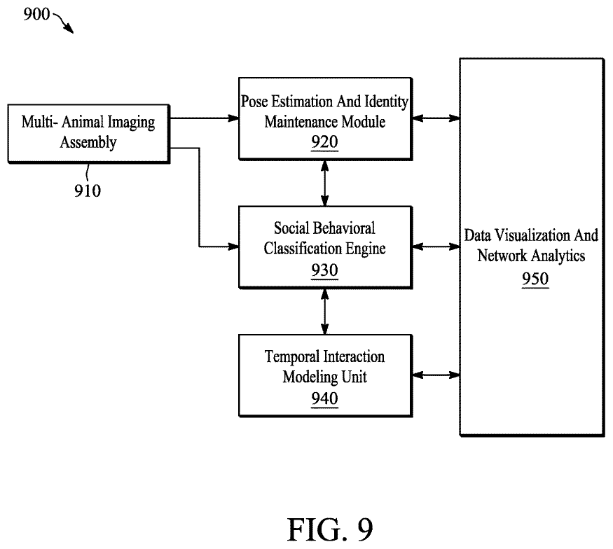

FIG. 9 illustrates an embodiment of a multi-animal behavioral tracking and social interaction analysis system 900, which forms an integral extension of the behavioral monitoring platform described in FIGS. 4 to 8. The social interaction analysis system 900 is configured to simultaneously monitor multiple rodents within a shared enclosure and to quantitatively characterize individual and group-level social behaviors through markerless computer vision and machine learning algorithms.

As shown in FIG. 9, the social interaction analysis system 900 comprises a multi-animal imaging assembly 910, a pose estimation and identity maintenance module 920, a social behavior classification engine 930, a temporal interaction modeling unit 940, and a data visualization and network analysis interface 950. Each component is operatively connected through a communication backbone that ensures synchronization and low-latency data transfer between modules.

The multi-animal imaging assembly 910 includes a set of synchronized cameras arranged to capture overlapping fields of view within the shared cage or arena. The cameras may include a top-mounted camera, lateral cameras, and a bottom-mounted camera to ensure full 3D coverage and minimize occlusion effects during high-density social interactions. The assembly further includes an infrared illumination array that allows video capture under both light and dark phases, thereby supporting circadian continuity as described in FIG. 8. Each camera stream is time-stamped by a synchronization controller to maintain precise alignment between frames.

The pose estimation and identity maintenance module 920 performs real-time detection and tracking of multiple animals within the same frame. The module incorporates a keypoint detection network, trained to identify a plurality of anatomical landmarks (nose, ears, forepaws, hindpaws, tail base, and tail tip) for each animal without requiring physical markers. A segmentation model generates a pixel-wise body mask for each detected animal, while a fusion processor integrates the skeletal and segmentation data to form a hybrid pose-mask representation, enabling improved performance under partial occlusion conditions.

Each animal is assigned a unique digital identity maintained across frames and sessions. The system uses a Kalman filtering unit to predict the spatial trajectory of each animal based on prior positions, velocities, and acceleration vectors. In parallel, an appearance re-identification network computes deep embedding vectors from each animal's fur texture, body contour, and motion signature. The embeddings are matched against a memory bank to recover individual identities after temporary occlusion or crossing events. Together, these processes ensure persistent and error-tolerant identity tracking even during close physical proximity or overlapping interactions.

The social behavior classification engine 930 is configured to automatically detect and categorize social interactions among animals. The engine receives time-synchronized pose and trajectory data from the identity maintenance module and computes a set of pairwise interaction features, including centroid distance, approach velocity, angular orientation, and contact duration. A behavioral event detector identifies specific interactions such as nose-to-nose contact, following, mounting, chasing, aggression, or affiliative grooming. The feature vectors are fed into a trained classification model, such as a random forest or transformer-based sequence classifier, which outputs discrete behavior labels along with confidence scores.

The temporal interaction modelling unit 940 characterizes dynamic transitions and sequential dependencies in social behavior over time. The unit includes a Hidden Markov Model (HMM) processor configured to model probabilistic transitions between interaction states, such as grooming→chasing→avoidance. In some embodiments, a non-parametric HDP-HMM variant is employed to automatically infer the number of latent behavioral states without manual annotation. A temporal alignment module synchronizes interaction events with circadian phase and environmental variables, allowing correlation of social rhythm disruptions with external stimuli or experimental conditions.

The data visualization and network analysis interface 950 represents interaction patterns in intuitive graphical formats. A social network generator constructs weighted graphs where nodes represent individual animals and edges represent interaction frequency, duration, or behavioral valence (affiliative or aggressive). A metric computation engine calculates social network parameters such as degree centrality, dominance index, and reciprocity ratio. A visualization display renders interactive timelines, adjacency matrices, and network diagrams that can be filtered by behavior type, confidence level, or circadian phase. Data outputs are exported in FAIR-compliant formats (JSON, HDF5) along with metadata describing the experimental setup and model versions.

In certain embodiments, the social interaction analysis system 900 further includes a social context inference module, which uses unsupervised clustering and dimensionality reduction techniques (e.g., t-SNE, UMAP) to discover latent group behaviors not predefined in the classifier. For example, spontaneous cooperative behaviors or dominance hierarchies can be inferred from emergent motion patterns. The inferred social clusters may be correlated with physiological or biochemical markers obtained via the sensing module of FIG. 7, enabling cross-domain analysis between social dynamics and biological responses.

The social interaction analysis system 900 may optionally integrate a human-in-the-loop validation interface, enabling researchers to review and correct automatically detected interaction events. Corrected annotations are fed back into a model retraining pipeline, improving classifier accuracy over time through adaptive learning. The retraining metadata, including correction timestamps and operator identifiers, are stored in a version-controlled dataset for transparency and reproducibility.

In operation, the social interaction analysis system 900 enables high-throughput, quantitative assessment of rodent social behaviors without manual intervention. By combining markerless tracking, persistent identity management, probabilistic temporal modeling, and graph-based visualization, the platform provides a comprehensive understanding of social structure and interaction patterns within a group. Such measurements are particularly valuable for preclinical models of neuropsychiatric and neurodegenerative disorders where social behavior is a critical phenotype.

Accordingly, FIG. 9 illustrates a robust, scalable, and data-rich framework for automated social behavior analysis that integrates seamlessly with the multimodal sensing, circadian tracking, and real-time processing infrastructures described in earlier embodiments. The system offers reproducible and FAIR-compliant behavioral phenotyping capabilities suitable for translational neuroscience and drug discovery applications.

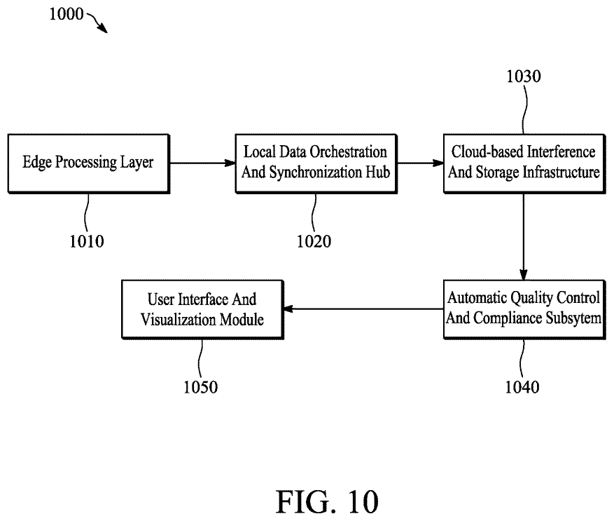

FIG. 10 illustrates an embodiment of a scalable, real-time data processing and cloud-based analytics architecture 1000, configured to support high-throughput behavioral experiments across multiple cages, experimental conditions, and laboratories. The real-time data processing and cloud-based analytics architecture 1000 enables real-time inference, edge-level preprocessing, cloud synchronization, and automated quality control for large-scale rodent behavioral studies.

As shown in FIG. 10, the real-time data processing and cloud-based analytics architecture 1000 comprises an edge processing layer 1010, a local data orchestration and synchronization hub 1020, a cloud-based inference and storage infrastructure 1030, an automated quality control and compliance subsystem 1040, and a user interface and visualization module 1050. These components are interconnected via a high-speed network backbone supporting Ethernet, Wi-Fi 6, or dedicated optical interconnects, depending on experimental scale.

The edge processing layer 1010 includes a plurality of GPU-equipped workstations or embedded edge devices positioned in proximity to each behavioral cage or recording unit. Each workstation is configured to receive multi-camera video streams and sensor data directly from the acquisition modules described in FIGS. 4 through 9. The workstation executes a real-time inference engine, which performs pose estimation, segmentation, and behavior classification using optimized convolutional and transformer-based neural networks. In one embodiment, each edge node processes up to four synchronized video channels at 30-120 frames per second, achieving a target throughput of ≤5 minutes computation per 10 minutes of recorded video.

The edge layer further comprises a preprocessing module that performs on-device frame compression, motion detection, and occlusion detection to reduce upstream data bandwidth. Low-confidence detections are filtered by a confidence thresholding unit, which dynamically suppresses unreliable outputs based on per-frame confidence maps and temporal continuity metrics. Only validated skeletal keypoints, segmentation masks, and behavioral event tags are transmitted to the local data orchestration and synchronization hub 1020, thereby minimizing redundant or low-value data transmission.

The local data orchestration and synchronization hub 1020 functions as an intermediary controller that aggregates data from multiple edge devices within a facility. The hub includes a data ingestion gateway, a time synchronization controller, and a metadata assembler. The time synchronization controller ensures frame-level alignment across cages using a network time protocol (NTP) or a GPS-synchronized clock. The metadata assembler attaches contextual descriptors such as experiment ID, cage number, animal ID, lighting condition, and firmware version to each data packet. A stream management module prioritizes data uploads based on network availability, automatically deferring low-priority transfers during bandwidth saturation.

The cloud-based inference and storage infrastructure 1030 provides elastic computing and long-term archival capabilities. The infrastructure includes a distributed GPU cluster that supports large-scale model inference, retraining, and batch analysis of archived datasets. A data lake repository stores all raw, processed, and metadata-enriched files in FAIR-compliant formats such as JSON, CSV, or HDF5. Each file is automatically indexed with unique identifiers (DOIs or UUIDs) to ensure findability and reproducibility. The repository further supports compliance with NIH DMS and NDHCC schema standards through an ontology tagging service, which embeds controlled vocabulary terms (UMLS, NINDS CDEs) and version metadata into each dataset. A scalable API gateway allows secure access for remote collaborators or external analytics platforms.

The automated quality control and compliance subsystem 1040 performs continuous validation of incoming data streams to ensure experimental consistency and technical robustness. The subsystem comprises a frame rate monitoring unit, a blur and occlusion detector, and a pose coverage evaluator. The frame rate monitoring unit checks for temporal stability and flags dropped frames or sensor desynchronization events. The occlusion detector applies frequency-domain variance analysis to identify degraded image quality due to vibration or focus loss. The pose coverage evaluator calculates the percentage of successfully detected keypoints per animal per frame, generating a quantitative measure of tracking completeness. An anomaly detection engine, employing unsupervised outlier detection algorithms, automatically identifies and quarantines datasets that deviate from expected statistical distributions.

In one embodiment, the automated quality control and compliance subsystem 1040 further interfaces with a compliance auditing module, which validates that exported datasets adhere to FAIR principles—findable, accessible, interoperable, and reusable. The module checks for metadata completeness, data structure integrity, and repository readiness. Datasets that pass validation receive a FAIR-compliance token appended to their metadata header, ensuring transparency and regulatory traceability.

The user interface and visualization module 1050 provides real-time and retrospective access to all system functions. The module includes a dashboard interface displaying live processing status, GPU utilization, and cage-level behavior summaries. A data visualization unit renders temporal behavior plots, confidence heatmaps, and 3D reconstructions derived from the integrated data. Researchers can interact with data using a query and annotation interface, allowing retrieval of specific animals, behaviors, or time windows. A workflow automation engine enables the scheduling of analyses, model retraining, and dataset exports to external repositories or regulatory portals. Access control and encryption mechanisms ensure secure data handling in compliance with institutional and governmental standards.

In certain embodiments, the real-time data processing and cloud-based analytics architecture 1000 supports federated learning across geographically distributed laboratories. Each site maintains local training datasets, while only model weight updates are transmitted to the GPU cluster for aggregation. This approach preserves data privacy while enabling global model improvement. A federated update manager ensures version control and differential weighting of model contributions based on data quality metrics from the QC subsystem.

The real-time data processing and cloud-based analytics architecture 1000 may also include a scaling controller, which dynamically allocates computing resources based on incoming workload. When new experimental sessions are initiated, the controller provisions virtual machines or containers on demand, scaling down resources during idle periods to conserve cost and power. The scaling controller may be governed by a resource optimization algorithm that balances latency, throughput, and computational load across the hybrid edge-cloud environment.

In operation, the real-time processing and cloud-based analytics architecture 1000 facilitates near-instantaneous analysis of complex behavioral datasets across multiple concurrent experiments. By integrating edge-based AI inference, centralized orchestration, cloud-level scaling, and automated quality control, the system ensures that high-volume behavioral data are processed efficiently, reproducibly, and in compliance with data-sharing standards.

Accordingly, FIG. 10 represents a robust and extensible computational backbone that underpins all preceding embodiments. It supports simultaneous multi-cage monitoring, continuous data validation, FAIR-compliant export, and collaborative research at scale, thereby enabling reproducible, translational behavioral neuroscience in both academic and preclinical environments.

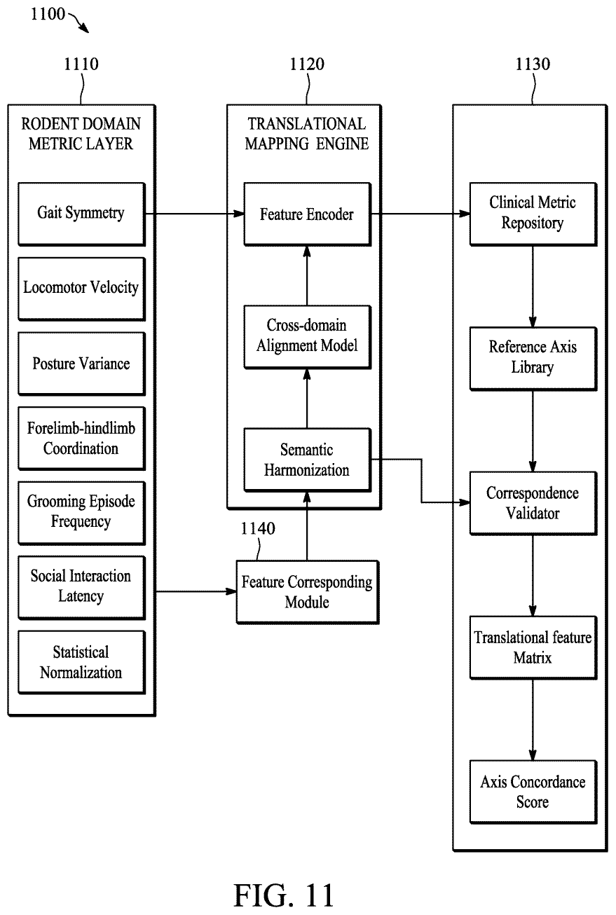

FIG. 11 illustrates an embodiment of a translational alignment framework 1100 designed to map rodent behavioral and kinematic parameters into standardized Neurobehavioral Assessment Matrix (NAM) or Standardized Translational-Motor Axis (ST-MAX) representations. The translational alignment framework 1100 enables cross-species interpretation of behavioral phenotypes by harmonizing animal-derived metrics with clinically recognized human motor, cognitive, and affective function axes.

As depicted, the translational alignment framework 1100 includes three principal layers: a rodent domain metric layer 1110, a translational mapping engine 1120, and a cross-domain alignment model 1130, interconnected through a feature correspondence module 1140. Each layer operates within a cloud-integrated environment and exchanges data via structured ontologies and standardized metric descriptors.

The rodent domain metric layer 1110 aggregates quantitative behavioral parameters derived from the machine-learning pipeline of FIGS. 4 to 10. These parameters include, without limitation, gait symmetry, locomotor velocity, posture variance, forelimb-hindlimb coordination, grooming episode frequency, and social interaction latency. Each metric is normalized against strain-, age-, and sex-matched baselines using a statistical normalization module to ensure inter-experiment comparability. The resulting standardized dataset forms a multi-dimensional behavioral signature vector for each animal or cohort.

The translational mapping engine 1120 functions as the analytical core of the framework. It includes a feature encoder, a cross-domain alignment model, and a semantic harmonization unit. The feature encoder compresses the multi-dimensional behavioral signature vector into a latent embedding space using a trained neural representation model. The cross-domain alignment model 1130 employs supervised or semi-supervised techniques to project rodent embedding into a shared translational manifold co-populated with human clinical reference data. In one embodiment, canonical correlation analysis (CCA) or manifold alignment via optimal transport is used to achieve correspondence between species-specific feature distributions.

The semantic harmonization unit associates each mapped latent dimension with clinically defined motor axes, such as fine motor control, gross motor coordination, cognitive flexibility, and affective modulation. This association is guided by curated ontology mappings drawn from recognized neurobehavioral datasets (e.g., NIH Common Data Elements, Human Phenotype Ontology). The outcome of the translational mapping engine 1120 is a translational feature matrix, where each rodent-derived behavior is expressed in human-interpretable units and variance structures.

The cross-domain alignment model 1130 comprises a clinical metric repository, a reference axis library, and a correspondence validator. The clinical metric repository contains benchmark datasets such as motion-capture-based gait analyses, tremor assessments, and reaction-time measures from human studies. The reference axis library defines canonical behavioral axes A₁-Aₙ, representing key dimensions of motor and neuropsychological function. The correspondence validator continuously evaluates the degree of alignment between rodent and human datasets, generating axis concordance scores that quantify translational fidelity. High concordance values indicate strong predictive potential of the preclinical model for human endpoints.

A feature correspondence module 1140 serves as the bidirectional interface between the rodent and human layers. It comprises a metric translation engine configured to convert rodent parameters into clinically interpretable units (e.g., gait cadence to step frequency in Hz) and a reverse inference engine that predicts underlying rodent behaviors likely responsible for observed human symptoms or motor patterns. The feature correspondence module 1140 also incorporates a scaling and calibration unit, which adjusts for anatomical and biomechanical differences, such as limb length ratios, body mass, and stride cycle duration, ensuring dimensional consistency across species.

In one embodiment, the translational alignment framework 1100 is implemented within the cloud architecture described in FIG. 10 and leverages the federated update manager to update the translational model using new clinical or preclinical datasets without direct data sharing. This distributed training preserves privacy while continuously improving mapping robustness across different species and disease models.

The translational alignment framework 1100 optionally includes a regulatory compliance and reporting subsystem configured to generate NAM-compliant data reports. These reports document the translational correspondence of behavioral outcomes, including statistical confidence intervals, alignment coefficients, and model validation metrics. Such documentation facilitates acceptance of digital rodent behavioral endpoints within regulatory submissions for New Approach Methodologies (NAMs) and preclinical efficacy studies.

During operation, data flow proceeds sequentially from rodent metrics through the mapping engine into the human domain references, resulting in a harmonized set of behavioral descriptors visualized via an axis concordance map. The axis concordance map provides researchers with an interactive visualization in which rodent behaviors (left-side axes) are dynamically linked to homologous human behavioral constructs (right-side axes). This enables intuitive inspection of cross-species correspondence and rapid identification of translationally relevant endpoints.

The translational alignment framework 1100 thereby establishes a quantifiable, reproducible, and regulatory-aligned methodology for integrating animal-based behavioral data with human clinical assessment paradigms. By grounding behavioral analysis in mathematically defined cross-species axes and FAIR-compliant metadata, the system advances the field toward reproducible, interpretable, and ethical preclinical research models.

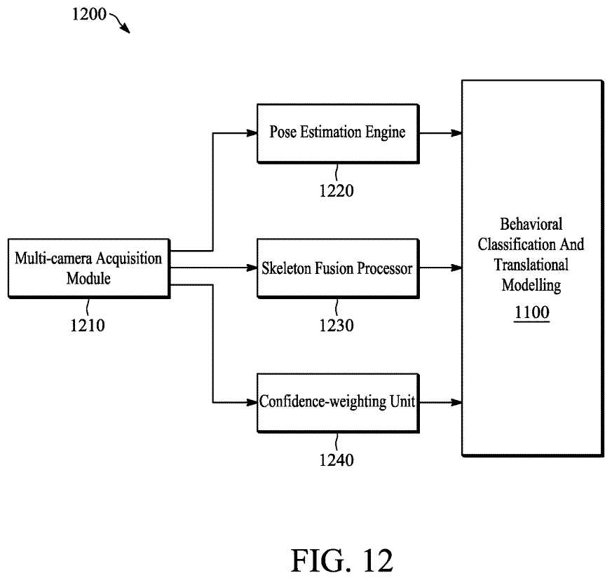

FIG. 12 illustrates an embodiment of an integrated anatomical skeleton mapping system 1200 that enables fine-grained motion reconstruction and pose analysis of small laboratory animals such as rodents. The anatomical skeleton mapping system 1200 combines keypoint detection, anatomical constraint modeling, and confidence-based fusion from multi-camera inputs to achieve sub-millimeter spatial accuracy and continuous temporal consistency in behavioral tracking.

The anatomical skeleton mapping system 1200 includes a multi-camera acquisition module 1210, a pose estimation engine 1220, a skeleton fusion processor 1230, and a confidence-weighting unit 1240, each operatively connected through a data bus and synchronized by a timing controller. In one embodiment, the modules are implemented as separate hardware-accelerated computational nodes within the GPU-based architecture previously described with reference to FIG. 10.

The multi-camera acquisition module 1210 comprises at least four synchronized cameras positioned in top, lateral, frontal, and bottom orientations relative to the animal enclosure. Each camera is calibrated using intrinsic and extrinsic parameters stored in a calibration matrix. A synchronization controller aligns frame timestamps to within ±2 milliseconds to ensure accurate temporal correspondence across all viewpoints. The bottom-mounted camera is optimized for detecting paw placement, toe spread, and ground-contact events, providing data not observable from overhead perspectives.

The captured video frames are transmitted to the pose estimation engine 1220, which employs a deep-learning network trained to detect anatomical landmarks, including, but not limited to, the nose N, ears E₁, E₂, forepaws F₁, F₂, hindpaws H₁, H₂, hips K₁, K₂, tail base T_{β}, and tail tip Tₜ. Each detected landmark is output as a coordinate tuple (x, y) or (x, y, z) along with a confidence score C ranging from 0 to 1, indicating the reliability of the detection. In one embodiment, the network employs a stacked-hourglass or transformer-based architecture that learns spatial dependencies among keypoints to reduce false detections in occluded or low-contrast regions.

The skeleton fusion processor 1230 integrates multiple 2-D keypoint sets from different camera views into a unified 3-D anatomical skeleton model. The anatomical skeleton mapping system 1200 executes a triangulation algorithm using camera projection matrices P₁-Pₙ and performs temporal smoothing via a Kalman filter to eliminate jitter and preserve biomechanical plausibility. The 3-D anatomical skeleton model comprises linked nodes representing joints and body segments, parameterized by inter-segment distances Lᵢ and angular constraints θᵢ consistent with rodent musculoskeletal geometry. These constraints ensure anatomical feasibility during motion reconstruction, preventing impossible limb configurations.

The confidence-weighting unit 1240 evaluates detection reliability across cameras and time frames. Each detected keypoint pᵢ from camera k is associated with a confidence value Cᵢₖ. The unit computes a global confidence score C̅ᵢ=Σₖ wₖ Cᵢₖ, where weights wₖ are determined dynamically based on camera quality metrics such as focus sharpness, illumination uniformity, and angle of incidence. Points with C̅ᵢ below a defined threshold are flagged as low-reliability and are either interpolated from previous frames or replaced using model-based prediction. This mechanism prevents propagation of erroneous detections into the fused skeleton.

The anatomical skeleton model is transmitted to a kinematic analysis module, which computes motion descriptors such as stride length S, gait cycle period τ, joint angular velocity ω, and body-axis inclination a. The module further calculates composite metrics such as coordination index, balance asymmetry, and postural stability. These metrics are subsequently stored in a feature database for downstream behavioral classification and translational modeling as described in FIG. 11.

In one embodiment, the anatomical skeleton mapping system 1200 additionally includes an anatomical prior model, stored in a memory unit, which encodes statistical distributions of joint angles and segment ratios derived from population data. During reconstruction, the prior model constrains the fused skeleton to remain within biologically plausible limits, thereby improving accuracy when certain keypoints are occluded or low-confidence. The prior model may be updated iteratively through human-in-the-loop verification cycles described earlier.

The anatomical skeleton mapping system 1200 may further integrate with a segmentation module that generates per-frame silhouette masks of the animal. The anatomical skeleton model and the silhouette are fused to validate limb placements relative to body contours and to estimate volumetric parameters such as body mass or swelling indices. This pose-plus-segmentation fusion approach enhances robustness under partial occlusion and variable lighting.

The integrated anatomical skeleton mapping system 1200 thus provides a comprehensive framework for high-precision, confidence-weighted, multi-camera behavioral analysis. By enforcing anatomical constraints and leveraging learned confidence metrics, the system produces biomechanically consistent 3-D reconstructions suitable for advanced machine-learning pipelines, gait quantification, and translational modeling of neurological and musculoskeletal disorders.

In certain embodiments, a negative dataset training and pose-segmentation fusion system is provided for improving the accuracy and robustness of animal behavior analysis. The system is configured to combine discriminative model training with hybrid spatial representations to suppress false keypoint detections, enhance occlusion tolerance, and generate anatomically consistent silhouette-skeleton mappings in real-time video analysis.

In one embodiment, the system includes a training data preparation unit, a pose estimation network, a segmentation network, a fusion processor, and a classification layer, which are functionally interconnected through a high-speed training bus or equivalent data transfer interface. The architecture may be implemented using a local GPU cluster or a cloud-based deep learning platform capable of processing large-scale annotated datasets.

The training data preparation unit comprises a positive dataset generator and a negative dataset generator. The positive dataset generator collects labeled video frames that contain clear animal postures, visible anatomical landmarks, and typical behavioral categories such as walking, grooming, rearing, and resting. The negative dataset generator, on the other hand, compiles images that either lack animals entirely or contain challenging conditions such as partial occlusions, overlapping individuals, or visually cluttered backgrounds. These negative samples are annotated with non-animal regions and occluded keypoint masks, thereby forming an explicit set of false-example conditions for robust discriminative learning.

During model training, the pose estimation network receives both positive and negative datasets. The network may be implemented using a convolutional neural network or transformer-based architecture, and may include feature extraction blocks, attention modules, and multi-scale heatmap decoders. A negative suppression module is incorporated within the loss computation to penalize network activations corresponding to background or occluded regions. In one embodiment, a dual-channel confidence loss function is utilized, expressed as

$$L = α {L}_{pos} + β {L}_{ne} g ,$$

where Lₚₒₛ promotes accuracy on positive samples and Lₙₑg penalizes activation in negative regions. The weighting coefficients α and β may be dynamically adjusted during training to balance learning between true and false examples.

In another embodiment, the segmentation network operates in parallel with the pose estimation network to produce per-pixel animal masks. The segmentation network may be trained using a combination of binary cross-entropy and intersection-over-union (IoU) loss functions to optimize foreground-background separation. In some implementations, a U-Net or equivalent encoder-decoder architecture with skip connections is used to preserve fine spatial details and ensure that silhouette boundaries accurately reflect the animal's body contour under diverse lighting and environmental conditions.

The fusion processor integrates outputs from both the pose estimation and segmentation networks. Each predicted keypoint, defined by its spatial coordinates and confidence score, is verified against the segmentation mask to assess spatial consistency within the animal's body contour. Keypoints that fall outside the silhouette or within low-confidence regions are flagged as invalid and re-estimated through interpolation or probabilistic correction based on local spatial priors. The fusion processor may also generate a hybrid representation map that overlays skeletal landmarks onto the corresponding silhouette, producing a fused pose-mask representation that maintains geometric coherence between the skeleton and the outer body contour.

In further embodiments, the classification layer utilizes the fused representation to identify distinct behavioral states. A fully connected neural network, optionally combined with a recurrent unit such as an LSTM or GRU, may analyze temporal sequences of fused frames to classify behaviors including rearing, circling, grooming, or freezing. The classifier generates discrete behavioral labels along with associated confidence metrics, which can be stored in a behavioral state database for longitudinal or comparative analysis.

In some embodiments, a post-fusion refinement module may be included to compute volumetric and biomechanical parameters such as body area, mass distribution, swelling indices, and energy expenditure estimates. By integrating silhouette-based volume estimations with skeletal joint coordinates, the system produces physiologically relevant metrics useful for studies of disease progression, therapeutic response, or injury recovery.

A feedback loop connects the classification output to the training data preparation unit to enable adaptive retraining. Misclassified or low-confidence samples are automatically flagged and incorporated into subsequent training cycles as additional positive or negative examples. This human-in-the-loop continuous learning process incrementally refines model performance over time, ensuring adaptability across new environments and species.

In one embodiment, a model training manager orchestrates the entire training and inference pipeline. The manager monitors GPU utilization, convergence metrics, and model validation accuracy, and automatically checkpoints the best-performing network weights. Trained models may be exported in metadata-rich, FAIR-compliant formats such as JSON or HDF5, annotated with ontology tags corresponding to behavioral domains and anatomical structures to support interoperability and regulatory transparency.

Accordingly, the described negative dataset training and pose-segmentation fusion system provides a robust, scalable, and generalizable architecture for high-fidelity quantification of animal behavior. Through the combination of explicit negative sampling, integrated pose-mask fusion, and adaptive feedback retraining, the system significantly reduces false detections, enhances resilience to occlusion, and yields anatomically consistent and interpretable motion representations suitable for scientific, translational, and regulatory applications.

In another embodiment, the system comprises a multi-domain behavior recognition layer configured to receive, process, and classify multidimensional data streams corresponding to movements, postural transitions, and activity sequences of one or more rodents. The multi-domain behavior recognition layer is implemented as a hardware-software hybrid module, in which one or more graphical processing units (GPUs) or dedicated neural processing units (NPUs) execute machine learning models stored in a non-transitory memory. The input to this layer may include fused data from multiple sensory modalities such as top-view and side-view video streams, infrared motion profiles, accelerometer readings, and biometric sensor outputs. Each incoming frame or sequence is preprocessed to extract feature vectors representing keypoints, velocity, orientation, limb articulation, and contextual attributes such as proximity to objects or conspecific animals.

The extracted features are transmitted to a feature embedding engine, which encodes the spatial-temporal characteristics into a latent vector representation. In certain embodiments, the embedding engine employs a convolutional neural network (CNN) backbone for spatial encoding, followed by a long short-term memory (LSTM) or transformer-based temporal encoder to capture inter-frame dependencies and long-range behavioral sequences. The resultant embeddings are used by a classification submodule that maps continuous pose data to discrete behavioral states such as walking, rearing, grooming, freezing, sniffing, aggression, or social interaction. The classification submodule may use supervised models such as random forest classifiers, support vector machines, or deep multilayer perceptrons trained on labeled ground-truth datasets.

In some implementations, the system also incorporates contextual and environmental variables to improve behavioral discrimination. For example, light-cycle conditions, time-of-day indices, and enclosure zone occupancy may be appended as auxiliary inputs to the behavioral recognition model. The classification results are further post-processed using a smoothing algorithm or hidden Markov model (HMM) to remove transient classification noise and to ensure temporal continuity in the detected behavioral states. The final output of this layer includes a time-stamped sequence of annotated behaviors, along with confidence scores and associated metadata.

In another aspect, the system supports an adaptive feedback mechanism wherein classification thresholds and model parameters can be dynamically updated based on user validation or automated quality assessment. The system can continuously learn from new datasets by retraining on misclassified or ambiguous samples, thereby improving the accuracy of behavioral detection over time. The behavior recognition layer may further generate summary statistics such as total duration, frequency, and transition probabilities among behavioral states, which can be visualized via a user interface or exported to downstream analytics modules.

In an exemplary configuration, the behavioral recognition outputs are linked with a hierarchical annotation engine that organizes detected behaviors into higher-order functional domains, including locomotor activity, exploratory behavior, affective response, and social interaction metrics. This hierarchical structuring enables comprehensive behavioral profiling and facilitates downstream analysis such as pharmacological response characterization, genetic model differentiation, and phenotype clustering.

In yet another embodiment, the system comprises a data standardization and FAIR-compliant export framework configured to ensure that all behavioral, imaging, and analytical outputs are organized, stored, and shared in accordance with established scientific data principles emphasizing findability, accessibility, interoperability, and reusability (FAIR). The framework operates as a dedicated data-handling subsystem integrated with the behavioral recognition layer and the downstream analysis modules. It is implemented through a combination of structured data repositories, standardized metadata schemas, and automated export utilities executed by the central controller or connected computing server.

Each behavioral session generates a dataset containing raw sensory inputs, pre-processed tracking data, feature embeddings, classification outputs, and temporal annotations. The FAIR-compliant export framework automatically parses these data elements and maps them into a unified schema, for example, in Hierarchical Data Format (HDF5) or JavaScript Object Notation (JSON), wherein each entry is tagged with unique identifiers, time indices, and contextual descriptors such as subject identity, experimental condition, and environmental parameters. The framework also records calibration constants, camera geometry matrices, and model version identifiers, thereby ensuring reproducibility and traceability of analytical results.

In some embodiments, the export framework includes a metadata generation engine that adheres to community data standards, such as the Open Neurophysiology Environment (ONE), Neurodata Without Borders (NWB), or comparable open-source ontologies. The metadata engine dynamically populates descriptive fields including species, strain, sex, age, experimental purpose, acquisition modality, and data provenance. These descriptors enable seamless integration of the collected datasets into external repositories and promote cross-study comparison.

The system further comprises a data packaging module configured to compress, encrypt, and transmit the standardized datasets to local or cloud-based data servers. The module may employ encryption protocols such as Advanced Encryption Standard (AES) for secure transfer, and maintain data integrity through checksum verification or cryptographic hashing. In another embodiment, the data packaging module is linked to a user-defined access-control system, permitting selective sharing of datasets with collaborators or regulatory bodies.

In an exemplary configuration, the export framework supports automated pipeline registration through machine-readable manifest files that describe the analytical workflow applied to each dataset. Such manifest files contain the specific preprocessing algorithms, behavioral classification models, and parameter settings used during analysis. This information allows third-party researchers or regulatory evaluators to reconstruct the analytical process and verify results without ambiguity.

In certain implementations, the FAIR-compliant export framework also enables bidirectional data exchange with external laboratory information management systems (LIMS) or centralized repositories. Through standardized application programming interfaces (APIs), the system can automatically upload newly processed datasets or retrieve reference data for comparative benchmarking. This interoperability supports large-scale meta-analysis, multi-site collaborations, and translational research aligning preclinical and clinical datasets.

The described framework not only facilitates transparent and reproducible data management but also provides the computational foundation for advanced analytics modules such as correlation mapping, predictive modeling, and translational concordance evaluation described in subsequent embodiments.

In another embodiment, the system further comprises a biological and imaging data correlation framework configured to associate behavioral parameters extracted by the machine learning modules with biological, molecular, and imaging-based endpoints. The framework serves as an integrative analytical layer that combines temporal behavioral signatures with multi-modal physiological or anatomical datasets, thereby facilitating comprehensive neurobiological interpretation and translational modeling.

The correlation framework is implemented through a modular data integration engine communicatively linked to the behavioral analytics processor, imaging data repositories, and biological assay databases. The behavioral analytics processor outputs quantitative behavioral metrics, such as stride length, velocity, angular displacement, grooming duration, rearing frequency, and spatial occupancy maps, along with corresponding timestamps. The imaging data repository provides datasets derived from modalities including magnetic resonance imaging (MRI), diffusion tensor imaging (DTI), positron emission tomography (PET), calcium imaging, or two-photon microscopy, while the biological assay database includes histological, electrophysiological, and proteomic measurements.

In one configuration, the integration engine aligns datasets temporally and spatially using metadata synchronization algorithms that match behavioral event timestamps to biological acquisition intervals. For example, post-injury rodent behavior recorded at week one may be algorithmically linked to histological or molecular outcomes obtained at week sixteen. A time-series regression model is then employed to predict long-term biological markers, such as synaptic protein density, neuroinflammation indices, or axonal integrity, from early-stage behavioral deviations.

In some embodiments, the integration framework employs statistical modeling tools including gradient boosting machines, support vector regressors (SVR), and random forest classifiers to generate predictive relationships between behavior and biology. Each model output is annotated with a confidence score or probability value indicative of model reliability. These outputs can be visualized as predictive biomarker maps, correlating specific behavioral clusters (e.g., asymmetric gait or repetitive circling) with corresponding molecular alterations.

In an exemplary implementation, the framework further includes a neuroimaging co-registration module configured to overlay 3D behavioral trajectories onto volumetric brain images. This allows the system to spatially associate distinct behavioral events with neural activation regions or lesion boundaries. The module employs affine or non-linear registration techniques to align coordinate systems between behavioral space and anatomical space.

In certain embodiments, the framework also incorporates a feature harmonization layer that normalizes and scales heterogeneous datasets originating from different laboratories or modalities. This layer applies z-score normalization, domain adaptation, or canonical correlation analysis (CCA) to ensure that behavioral, imaging, and molecular features are represented in a consistent multidimensional space suitable for downstream statistical inference.

Additionally, the biological correlation framework may provide a translational alignment interface that projects preclinical behavioral features into standardized human clinical metrics. For example, gait and balance features extracted from rodent models, such as stride symmetry, cadence, or limb coordination, can be algorithmically mapped onto human clinical assessment scales such as the Timed Up and Go (TUG) test, the 10-Meter Walk Test (10MWT), or the Fugl-Meyer Motor Scale. This projection is performed through a cross-species normalization matrix or learned transformation function (W-matrix) that quantifies conserved kinematic dimensions between species.

In another embodiment, the correlation framework includes a biological prediction dashboard providing visual outputs of the inferred biological state, including confidence intervals, significance levels, and deviation maps relative to healthy controls. The dashboard may be integrated within a web-based graphical user interface accessible to researchers for real-time hypothesis testing or experimental monitoring.

The described biological and imaging data correlation framework thus establishes a closed-loop analytical ecosystem, wherein behavioral phenotyping informs biological interpretation, and biological endpoints refine behavioral models, creating a continuously improving, cross-modal understanding of disease progression and therapeutic efficacy.

In another embodiment, the invention provides a continuous home-cage and circadian monitoring framework configured to record, analyze, and interpret rodent behaviors over extended durations, including nocturnal and diurnal cycles, without human intervention. This subsystem enables long-term, non-invasive tracking of individual or group animals in their native environments to evaluate naturalistic behaviors, sleep patterns, social interactions, and circadian rhythm fluctuations.

The monitoring framework comprises a sensor-integrated cage module equipped with multiple vision and environmental sensing components. Each cage module may include at least one top-mounted camera, one or more side-view or oblique cameras, and optionally a bottom-mounted infrared camera optimized for capturing paw placement, postural transitions, and substrate interaction. The cameras are connected to a real-time data acquisition controller that synchronizes video capture across multiple views and time domains. The controller ensures frame-level temporal alignment and manages the switching between infrared and red-light imaging modes, thereby allowing uninterrupted observation during dark cycles while minimizing behavioral disturbance.

In certain embodiments, the cage module further integrates a multimodal environmental sensor array that continuously monitors cage conditions, including temperature, humidity, ambient light intensity, sound levels, and vibration. The environmental parameters are recorded concurrently with behavioral data to permit correlation analysis between habitat conditions and behavioral variations. Additionally, the cage module may include smart feeding stations and water dispensers equipped with weight or proximity sensors for quantifying feeding and drinking frequency.

The data collected from each sensor stream is processed by a circadian analytics engine implemented on a local computing node or edge processor. The engine segments the 24-hour behavioral timeline into light and dark phases and quantifies activity metrics such as movement velocity, resting duration, nesting events, and exploratory distance traveled. Circadian indices, such as activity amplitude, phase onset, and rhythm stability, are derived from the temporal distribution of locomotor and resting states. In an exemplary embodiment, the analytics engine applies a Fourier or Lomb-Scargle periodogram to identify rhythmic components within the behavior time series, thereby enabling objective quantification of circadian periodicity.

The system further comprises a behavioral state classifier trained to distinguish between behavioral categories such as sleep, feeding, grooming, locomotion, and social interaction under varying illumination and environmental conditions. The classifier receives both image-based features and environmental sensor metadata as input to ensure accurate state identification even during low-visibility phases. The classified outputs are stored in a longitudinal behavioral database, where each event is indexed by time, animal identity, environmental context, and corresponding video frames.

In some embodiments, the home-cage monitoring framework supports multi-animal configurations, allowing simultaneous tracking of multiple subjects within the same enclosure. Identity continuity is maintained through a combination of appearance-based re-identification models and spatial trajectory association using Kalman filtering. This enables the extraction of social and group-level metrics such as proximity networks, approach/withdrawal frequency, and collective activity synchronization.

The framework also includes a circadian health assessment interface configured to visualize key metrics such as total activity, rest-activity ratio, circadian phase shifts, and anomalies indicative of neurological or pharmacological effects. The interface may further integrate predictive modules that relate circadian disruption patterns to potential neurodegenerative or stress-related biomarkers.

In certain embodiments, the continuous monitoring system operates in conjunction with a cloud-based data synchronization module, allowing remote researchers to access real-time behavioral summaries, environmental telemetry, and raw video recordings. The cloud module ensures data integrity through automated redundancy, encryption, and timestamp validation consistent with FAIR (Findable, Accessible, Interoperable, and Reusable) data principles.

Through the combination of multimodal sensing, automated analytics, and circadian pattern extraction, the continuous home-cage and circadian monitoring framework provides a scalable and reproducible platform for capturing long-term physiological and behavioral dynamics, offering essential insight into neurological function, disease progression, and therapeutic outcomes under naturalistic living conditions.

In another embodiment, the invention provides a multi-animal and social interaction tracking framework configured to perform real-time, markerless tracking and behavioral interpretation of multiple rodents within a shared enclosure. This framework enables the quantitative analysis of social behaviors, dominance patterns, affiliative interactions, and group dynamics in both controlled and naturalistic settings.

The system comprises a multi-view imaging array including a plurality of cameras positioned around the experimental cage or arena to capture synchronized top, side, and oblique perspectives. Each camera is communicatively coupled to a multi-stream synchronization controller that ensures precise frame alignment and temporal consistency across all video feeds. The captured frames are transmitted to a multi-animal pose estimation engine executed on a local GPU-enabled processing unit or a distributed cloud inference server.

The pose estimation engine employs a deep convolutional neural network configured to detect and localize anatomical keypoints for each animal in every frame, including nose, ears, forepaws, hindpaws, hip, tail base, and tail tip. The model produces both spatial coordinates and confidence scores for each detected keypoint. To maintain individual identity over time, a Kalman-based identity tracker is employed to estimate continuous trajectories, even during transient occlusions or overlapping body positions. When two or more animals become partially or fully occluded, an appearance-based re-identification module computes embedding vectors representing texture, shape, and motion features of each individual. These embeddings are matched with pre-stored identity profiles to recover accurate tracking continuity once occlusion resolves.

In one embodiment, the system further includes a social behavior inference engine configured to compute interaction metrics between animals based on inter-individual distances, approach and withdrawal velocities, and joint orientation vectors. The inference engine detects events such as following, approaching, chasing, mounting, grooming, and aggression. Each event is assigned a classification label, timestamp, and confidence score, forming a continuous log of social interactions throughout the experiment.

In certain configurations, the framework implements a Hidden Markov Model (HMM)-based social sequence analyzer, which segments continuous interaction data into discrete behavioral episodes and identifies transition probabilities between behaviors. For instance, the model can recognize interaction sequences such as “approach→mutual sniffing→grooming→retreat” or “approach→chasing→aggressive contact→separation.” These sequences provide quantitative insight into social organization, anxiety phenotypes, and dominance hierarchies.

The extracted interaction features are compiled into a social network graph, wherein nodes represent individual animals and edges represent interaction strength or frequency. Edge weights are computed from cumulative proximity duration, grooming frequency, or aggressive contact count. The resulting network graph visually and quantitatively represents social structure, including dominance indices, affiliative tendencies, and avoidance relationships.

The system optionally includes a social behavior visualization dashboard that presents real-time or recorded playback of the tracked animals with overlaid trajectories, identity markers, and classified behaviors. The dashboard may also include adjustable filters for viewing specific time windows, behaviors, or pairwise interactions. Data outputs may be exported as structured JSON, CSV, or HDF5 files containing detailed per-frame annotations and metadata such as animal ID, position, orientation, and behavioral state.

In some embodiments, the multi-animal tracking framework is integrated with the home-cage monitoring subsystem to enable 24/7 social interaction assessment under naturalistic conditions. This integration permits continuous evaluation of social behaviors over circadian cycles, stress paradigms, or pharmacological interventions. Additionally, confidence-weighted filtering mechanisms are employed to ensure robustness of detections under low lighting, infrared illumination, or partial occlusion.

The described multi-animal and social interaction tracking framework thereby enables reproducible, quantitative, and automated characterization of complex group dynamics, serving as an essential analytical module for studies in neurobehavioral disorders, drug efficacy testing, and social phenotype differentiation.

In another embodiment, the invention provides a scalable, real-time processing and cloud architecture framework designed to enable parallelized, high-throughput analysis of behavioral and biological datasets across multiple experimental cages, laboratories, or research facilities. The framework is configured to maintain low-latency data transfer, GPU-accelerated inference, and automated quality assurance, ensuring reliable and reproducible performance at scale.

The system architecture comprises a hierarchical computing structure that includes local edge devices, central GPU workstations, and a cloud-based orchestration server. Each local edge device is physically connected to one or more camera modules and environmental sensors positioned within individual cages. The edge devices perform initial preprocessing operations, including frame compression, motion detection, and background subtraction, thereby reducing data volume prior to network transmission. Processed video packets and sensor streams are then transmitted via a secure data channel to the central GPU workstations, which execute real-time inference pipelines for pose estimation, segmentation, and behavioral classification.

The GPU workstations are configured with multi-threaded inference pipelines that allocate separate processing threads for each incoming cage stream. Each thread manages frame buffering, model inference, and data caching independently to ensure continuous throughput without frame loss. The pipelines leverage deep learning accelerators and CUDA-based libraries to achieve processing speeds ranging from 30 to 120 frames per second, depending on the complexity of the behavioral scene. The orchestration server dynamically manages computational resources by distributing inference workloads across available GPU nodes, ensuring balanced utilization and fault tolerance in case of hardware or network interruptions.

In certain embodiments, the cloud orchestration layer also includes a data quality control module configured to automatically evaluate the integrity of processed frames and model outputs. This module implements a series of automated validation checks, including frame-rate consistency analysis, motion blur detection using Fast Fourier Transform (FFT) variance, occlusion quantification (percentage of lost or low-confidence keypoints), and lighting normalization metrics. Frames or sessions failing quality thresholds are flagged for human review or automated reprocessing.

In some configurations, the architecture further includes a real-time feedback interface that allows experimenters to view ongoing analyses through a secure web dashboard. The dashboard displays live camera feeds, detected keypoints, behavioral classifications, and environmental telemetry data. The interface also supports command-level control, permitting users to initiate, pause, or modify ongoing recording sessions, as well as adjust model parameters dynamically.

The system may further include a data aggregation and analytics layer hosted on the cloud server. This layer aggregates outputs from multiple cages or laboratories, enabling cross-experiment statistical comparison, large-scale cohort analysis, and meta-learning. Aggregated datasets can be queried through structured APIs or exported in standardized formats such as JSON, HDF5, or FAIR-compliant repositories. The architecture supports automatic metadata embedding, including experimental identifiers, device configurations, timestamps, and version control tags for each dataset.

In another embodiment, the framework incorporates a scalability controller that monitors computational load, memory usage, and network bandwidth to dynamically allocate processing instances. For instance, during periods of high data throughput, the system may temporarily offload specific video streams to secondary cloud instances or batch-process non-critical frames to maintain latency requirements. The target performance benchmark for the architecture is defined as less than or equal to five minutes of processing time for every ten minutes of recorded video, achieved through distributed parallelism and resource optimization.

The framework may optionally integrate with a continuous model training service that aggregates new annotated data and retrains inference models periodically using federated learning. This ensures consistent model performance across different laboratories without requiring centralization of sensitive datasets. Model updates are versioned and automatically deployed to all connected edge devices, enabling synchronized performance improvements across the network.

Collectively, the scalable, real-time processing and cloud architecture framework establishes a distributed, fault-tolerant, and self-optimizing infrastructure capable of supporting large-scale behavioral and biological studies. It provides the computational backbone required for real-time behavioral analytics, cross-laboratory reproducibility, and continuous scientific data generation under standardized performance guarantees.

In another embodiment, the system includes a Translational Neurobehavioral Alignment and Mapping (NAM)/Standardized Motor Axis (ST-MAX) Framework, configured to bridge the gap between preclinical rodent behavioral metrics and standardized human motor function assessments. This framework enables quantitative cross-species comparison and regulatory alignment, ensuring that preclinical behavioral data can be meaningfully interpreted in the context of human clinical outcomes.

The translational framework comprises a feature alignment module, a cross-species projection operator, and a metric concordance computation unit. The feature alignment module receives rodent-derived behavioral features from prior analytical layers, including stride length, duty cycle, tremor amplitude, paw overlap ratio, and gait symmetry indices. These features are normalized and structured into a rodent motor feature vector (R₁, R₂, R₃ . . . Rₙ). Simultaneously, the system accesses a human reference dataset comprising digital gait and balance data derived from clinical assessments such as the Timed Up and Go (TUG) test, the 10-Meter Walk Test (10MWT), and the Fugl-Meyer motor scale, along with smartphone or wearable sensor data capturing human locomotor signatures.

The cross-species projection operator applies a transformation matrix (W) that maps the rodent motor feature vector into a human motor axis space, comprising five conserved functional domains: (i) Symmetry, (ii) Stability, (iii) Speed/Tempo, (iv) Smoothness, and (v) Coordination. Each domain corresponds to a continuous dimension derived from human motor behavior distributions, providing a standardized axis system for comparative analysis. The transformation is performed using one or more machine learning or statistical alignment methods, including canonical correlation analysis (CCA), manifold learning, or supervised transfer learning algorithms trained to maximize inter-domain correspondence.

In one embodiment, the Axis Concordance Index (ACI) is computed by the metric concordance computation unit as a measure of the similarity between rodent and human motor signatures within the mapped domain. The ACI may be computed using statistical similarity measures such as the Bhattacharyya coefficient, cosine similarity, or Kullback-Leibler divergence. A threshold-based interpretation is applied, wherein axis mappings with ACI values above 0.60 are retained as translationally valid, while mappings below 0.55 are flagged for further validation or excluded from regulatory modeling.

In certain embodiments, the framework further incorporates a regulatory data harmonization module that automatically annotates all computed metrics with standardized ontology tags derived from the National Institute of Neurological Disorders and Stroke (NINDS) Common Data Elements (CDEs) and the National Data Harmonization and Coordination Center (NDHCC) schemas. This ensures that all translational outputs are FAIR-compliant (Findable, Accessible, Interoperable, Reusable) and immediately compatible with regulatory or clinical data repositories.

The translational framework may also include a human anchor calibration engine, configured to periodically recalibrate the transformation matrix (W) based on updated clinical datasets or new human digital health records. This calibration engine enables dynamic model adaptation and continuous improvement of cross-species predictive accuracy. In some configurations, calibration utilizes human gait data captured via smartphone accelerometers, inertial measurement units (IMUs), or laboratory-grade motion capture systems, thereby ensuring population-level generalizability.

Additionally, a translational analytics interface provides researchers with visual feedback of the mapped metrics, displaying comparative motor axis plots, deviation maps, and statistical overlays between rodent and human populations. The interface may generate quantitative summaries such as “cross-species motor concordance scores,” “axis-wise behavioral divergence,” and “predicted human phenotype correlations,” which are exportable as structured digital reports for regulatory submission or cross-institutional data sharing.

In another embodiment, the framework integrates a validation and benchmarking module that evaluates the reproducibility of the translational mappings across independent datasets. This module performs cross-validation against known disease models, pharmacological interventions, or genetic perturbations to assess whether observed rodent behaviors predict corresponding human motor deficits or therapeutic recoveries with statistically significant correlation.

The Translational NAM/ST-MAX Alignment Framework thereby creates a quantitative bridge between animal and human motor domains, providing a scientifically rigorous and regulatory-compliant foundation for preclinical-to-clinical translation. Through this architecture, rodent-derived behavioral metrics can be expressed in human-relevant motor coordinates, thereby facilitating decision-making in drug discovery, neurological research, and regulatory validation pipelines.

In accordance with one or more embodiments of the present invention, a method of performing automated behavioral and translational analysis is disclosed. The method enables objective, high-throughput assessment of subject behavior using a hybrid combination of hardware imaging systems and software-implemented analytical algorithms. The described method ensures reproducible data generation, cross-species comparability, and regulatory compliance for translational neuroscience, pharmacology, or behavioral research.

In one embodiment, the method begins by capturing multi-view image data of a subject located within a behavioral testing enclosure using a plurality of imaging devices positioned at predetermined angles. Each imaging device may comprise a visible light camera, infrared camera, or depth sensor configured to continuously record at frame rates ranging from 60 to 240 frames per second. The system controller initiates synchronized recording by transmitting a trigger pulse to all imaging devices, thereby ensuring temporal alignment between camera streams. Environmental sensors such as temperature, humidity, or acoustic detectors may also be activated to record contextual metadata associated with each session.

The captured image sequences are transmitted to a local or remote processing unit, where a preprocessing routine normalizes illumination, compensates for camera-specific distortions, and synchronizes frames. In some embodiments, a temporal alignment algorithm is employed to correct microsecond-scale discrepancies between image feeds, thus preserving temporal precision for motion analysis. The normalized image data are stored in a buffer memory and indexed by session, subject ID, and timestamp.

Following synchronization, the method proceeds with extracting anatomical keypoints of the subject using a machine-learning model trained on labeled posture datasets. In one embodiment, a convolutional neural network (CNN) or transformer-based pose estimation network is applied to each frame to determine the pixel coordinates of relevant anatomical landmarks such as nose, ears, paws, tail base, and joints. The keypoints are aggregated across frames to form temporal skeleton sequences representing continuous postural trajectories.

The method may optionally employ a multi-view triangulation procedure to reconstruct three-dimensional coordinates of the extracted keypoints. By combining the intrinsic and extrinsic calibration parameters of the imaging devices, the algorithm performs epipolar geometry computations to derive spatial depth information, thereby producing accurate 3D skeletal models of the subject. Such reconstruction improves robustness to occlusions and enables detailed quantification of locomotor, rearing, or grooming behaviors.

The next step comprises computing behavioral features derived from the extracted keypoint data. The system calculates motion vectors, angular displacements, velocity profiles, stride cycles, and inter-limb coordination indices using time-domain and frequency-domain analyses. Parameters such as stride length, duty cycle, paw overlap ratio, tremor amplitude, and gait symmetry are computed automatically through algorithmic feature extractors implemented within the software framework.

In some embodiments, statistical filtering techniques such as Savitzky-Golay smoothing or Kalman filtering are employed to remove noise and jitter from the positional data. Derived parameters are compiled into a behavioral feature vector for each analyzed time segment, thereby converting continuous motion data into a structured quantitative representation suitable for classification.

The computed feature vectors are then supplied to a behavioral classification algorithm configured to categorize the subject's behavior into defined states. The classifier may comprise a convolutional neural network, a recurrent neural network, or a hybrid deep learning architecture trained on annotated behavioral video datasets. Typical behavioral categories include locomotion, rearing, grooming, freezing, exploration, or resting. The algorithm outputs both the predicted class and a probability score indicating the model's confidence for each behavioral segment.

In certain implementations, the classification algorithm operates in an online adaptive mode, wherein classification thresholds are dynamically updated based on recent feature statistics, environmental context, or reinforcement feedback from user-validated sessions. This adaptive learning mechanism enhances model accuracy and reduces drift across extended studies.

The method further comprises correlating the classified behavioral data with one or more physiological or pharmacological datasets obtained from concurrent experimental measurements. Such datasets may include electrophysiological recordings, neurochemical assays, imaging biomarkers, or administered compound profiles. The correlation engine aligns behavioral events with physiological timestamps to generate multimodal data associations, enabling inference of causal relationships between neural activity, treatment effects, and behavioral outcomes.

In an exemplary implementation, the system computes statistical relationships such as Pearson correlation coefficients, Granger causality metrics, or multivariate regression mappings between behavioral feature vectors and physiological signals. These relationships are stored within a relational database and annotated with experiment identifiers for subsequent retrieval or comparative analysis.

After correlation, the method includes projecting the correlated data into a standardized motor axis framework to generate translational mappings between animal and human behavioral metrics. The system constructs a transformation matrix derived from canonical correlation analysis or supervised transfer learning models trained on paired animal-human datasets. The behavioral features are projected onto human-relevant domains such as symmetry, stability, speed, smoothness, and coordination, forming a quantitative alignment between species.

The method computes an Axis Concordance Index (ACI) to quantify similarity between the mapped animal and human feature distributions. ACI values above a predefined threshold indicate valid translational correspondence, while lower values may prompt model recalibration. This projection step enables regulatory-grade comparison of preclinical and clinical motor function outcomes.

Finally, the method includes exporting all derived behavioral, physiological, and translational data in a standardized format compliant with FAIR data principles. Metadata descriptors are automatically appended, including experiment identifiers, sensor configurations, software version information, and calibration constants. The data are stored locally or transmitted to secure cloud servers using encrypted channels such as HTTPS or AES-based protocols. Each dataset is accompanied by a machine-readable manifest file describing the analytical workflow, thereby ensuring reproducibility and compliance with regulatory documentation requirements.

In some embodiments, the system provides an automated interface for external integration with Laboratory Information Management Systems (LIMS) or centralized data repositories. The exported files may follow standardized formats such as HDF5, JSON, or Neurodata Without Borders (NWB), facilitating seamless data sharing and interoperability across research institutions.

Through the described sequence of steps: multi-view capture, keypoint extraction, behavioral computation, classification, correlation, translational projection, and standardized export. The method enables an end-to-end pipeline for objective, reproducible, and interpretable behavioral analysis. The disclosed approach not only automates complex behavioral assessments but also provides a robust bridge between preclinical and clinical research domains, thereby advancing translational validity in neuroscience and pharmacological development.

Traditional systems often struggle with maintaining continuous and precise tracking of multiple anatomical points on rodents, especially in dynamic or cluttered environments. The disclosed system integrates multiple high-resolution cameras and sophisticated tracking algorithms to ensure consistent and accurate monitoring of the rodent's anatomical points over time.

Existing solutions frequently encounter delays or data bottlenecks due to the high volume of video data and the complexity of real-time processing requirements. The disclosed system employs a computing device with advanced processing capabilities and efficient data handling mechanisms to perform real-time analysis without lag, ensuring timely feedback on rodent behaviour.

Conventional methods may lack the capability to classify and interpret complex behavioural patterns accurately. By incorporating a machine learning model, the disclosed system enhances the ability to classify diverse behavioural states and detect subtle behavioural changes, providing a more comprehensive understanding of the rodent's activity and responses.

Many existing systems offer limited or cumbersome interfaces for data visualization and interaction, making it challenging for researchers to interpret results quickly. The disclosed system features a user-friendly graphical interface that presents real-time data in an intuitive format, allowing researchers to easily access, review, and manipulate behavioural data for deeper analysis.

Existing solutions may not scale efficiently or integrate seamlessly with other research tools and data sources. The disclosed system is designed for scalability, capable of handling multiple rodents and integrating with external devices and databases, thereby accommodating a wide range of research needs and experimental setups.

As will be appreciated by those skilled in the art, the techniques described in the various embodiments discussed above are not routine, or conventional, or well-understood in the art.

The illustrated steps are set out to explain the exemplary embodiments shown, and it should be anticipated that ongoing technological development will change the manner in which particular functions are performed. These examples are presented herein for the purpose of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. It is intended that the disclosure and examples be considered as exemplary only.

1. A behavioral analysis system, comprising:
a housing configured to be positioned adjacent to an experimental enclosure;
a plurality of imaging devices mounted within the housing and oriented toward a behavioral region of a subject;
an illumination assembly comprising at least one infrared light source configured to provide uniform lighting within the behavioral region;
a processing unit communicatively coupled to the imaging devices;
a memory storing instructions executable by the processing unit to generate synchronized multi-view video data representing movement of the subject within the behavioral region; and
wherein the system is configured to capture and store high-fidelity spatiotemporal movement data of the subject for subsequent behavioral analysis.

2. The system of claim 1, wherein the plurality of imaging devices comprises at least one wide-angle camera and one depth-sensing camera configured to generate three-dimensional representations of the subject.

3. The system of claim 1, wherein the illumination assembly further comprises a variable intensity controller configured to adjust infrared power based on ambient light conditions.

4. The system of claim 1, wherein the housing further comprises vibration isolation mounts and heat dissipation vents to maintain consistent sensor calibration and minimize motion artifacts.

5. The system of claim 1, further comprising a temperature and acoustic sensor configured to record environmental parameters corresponding to each behavioral session.

6. The system of claim 1, wherein the processing unit further comprises an embedded graphics processing module configured to perform frame synchronization and video compression in real time.

7. The system of claim 1, wherein the behavioral region is enclosed by transparent panels having anti-reflective coatings to enhance optical clarity.

8. The system of claim 1, wherein the imaging devices are mounted at predefined angular orientations forming a calibrated multi-view array to enable three-dimensional reconstruction of subject posture.

9. The system of claim 1, wherein the memory further stores calibration matrices corresponding to intrinsic and extrinsic camera parameters for stereoscopic depth computation.

10. A behavioral analytics system, comprising:
at least one camera configured to capture video footage of a rodent within an enclosure;
a processing unit configured to receive and process tracking data from the camera;
a graphical user interface (GUI) configured to display real-time tracking metrics;
a behavioral recognition module implemented in software and executed by the processing unit, the module comprising:
a motion detection unit configured to extract temporal features from the captured video footage;
a pose estimation unit configured to determine anatomical keypoints of the rodent using a convolutional neural network; and
a behavioral classification unit configured to categorize behavioral states based on extracted kinematic features;
a data correlation module configured to associate the classified behaviors with physiological or pharmacological input data; and
a translational analysis framework configured to project the behavioral features onto standardized human motor axes for cross-species comparison.

11. The system of claim 10, wherein the behavioral recognition module utilizes a deep neural network trained on multi-angle video data annotated with locomotor, grooming, and rearing behaviors.

12. The system of claim 10, wherein the translational analysis framework computes a concordance index representing similarity between animal and human motor feature distributions.

13. The system of claim 10, further comprising a data export module configured to format behavioral outputs according to FAIR data standards and transmit said data to an external server.

14. The system of claim 10, wherein the behavioral recognition module further includes a reinforcement learning subroutine configured to adapt classification thresholds based on new experimental data.

15. The system of claim 10, wherein the data correlation module integrates biological readouts selected from electrophysiological, neurochemical, or imaging data streams.

16. The system of claim 10, wherein the translational analysis framework employs a transformation matrix trained using canonical correlation analysis to align rodent motor feature vectors with human motor domains comprising symmetry, stability, speed, smoothness, and coordination.

17. A method of performing automated behavioral and translational analysis, comprising:
capturing multi-view image data of a subject within an experimental region using a plurality of imaging devices;
preprocessing the image data to synchronize frames and normalize illumination;
extracting anatomical keypoints of the subject by applying a machine-learning model to the image data;
computing behavioral features including stride length, angular displacement, and inter-limb coordination;
classifying the subject's behavior based on said features using a behavioral classification algorithm;
correlating the classified behavior with one or more physiological or pharmacological datasets; and
projecting the correlated data into a standardized motor axis framework to generate a translational mapping between animal and human behavioral metrics.

18. The method of claim 17, further comprising performing postural reconstruction of the subject by triangulating two-dimensional keypoints from multiple synchronized camera views.

19. The method of claim 17, wherein the behavioral classification algorithm comprises a convolutional neural network trained on labeled behavioral video datasets.

20. The method of claim 17, further comprising exporting all derived behavioral and translational data in a standardized FAIR-compliant format for regulatory submission or external data sharing.
